(19) United States
(12) Patent Application Publication
(10) Pub. No.: US 2015/0095426 A1
(43) Pub. Date: Apr. 2, 2015

(54) SERVER, TERMINAL MANAGEMENT METHOD, TERMINAL, AND STORAGE MEDIUM

(71) Applicant: Sharp Kabushiki Kaisha, Osaka (JP)

(72) Inventor: Motoki SONE, Osaka-shi (JP)

(73) Assignee: SHARP KABUSHIKI KAISHA, Osaka (JP)

(21) Appl. No.: 14/496,017

(22) Filed: Sep. 25, 2014

(30) Foreign Application Priority Data
Sep. 27, 2013 (JP) 2013-202484

(51) Int. Cl. H04L 29/06; G06Q 50/00

(52) U.S. Cl. CPC H04L 65/403; G06Q 50/01
USPC 709/204

(57) ABSTRACT

A server includes a transmitting unit, a receiving unit, and a terminal managing unit, wherein the transmitting unit transmits, to the subject terminal, information for causing the subject terminal to display thereon a first use condition and information for causing the subject terminal to display thereon an acceptance object for accepting a first input indicating a user's consent to the first use condition, and in a case where the receiving unit receives, from the subject terminal, information indicating acceptance of the first input, the terminal managing unit performs a first registration of the subject terminal.

This nonprovisional application claims priority under 35 U.S.C. §119 on Patent Application No. 2013-202484 filed in Japan on Sep. 27, 2013, the entire contents of which is hereby incorporated by reference.

### TECHNICAL FIELD

The present invention relates to a server that offers a social networking service to enable a message to be shared among individual terminals, a terminal management method involved in the social networking service, and a terminal in the social networking service. Further, the present invention relates to a storage medium storing therein a program for causing a computer to function as the server.

### BACKGROUND ART

In recent years, there has been the widespread use of services to make communications among specific people in a virtual space formed by an electrical communication network such as an Internet. These services are generally termed “social networking services” (abbreviated as “SNS”). The total number of the specific people who make communications with each other through the use of the SNS comes to a plurality of people and comes to several hundreds of people in a large scale.

The use of the conventional SNS requires, to begin with, registration of personal information for identifying a user who uses the SNS (registration of an account) on a server provided by a SNS service provider. Hereinafter, the user who uses the SNS is also referred simply to as the user. Thereafter, the user searches for personal information of an acquaintance who registered in the same manner in the past and then sends the acquaintance a request for a permission to communicate with the acquaintance (peer request). If the acquaintance, in response to the peer request, gives the user the permission, the user can add the acquaintance as a peer and communicate with the acquaintance in future.

(Registration)

More specifically, the user registers personal information, which is predetermined by the SNS service provider, on the server provided by the SNS service provider. The personal information includes a password required to use the SNS. The server provided by the SNS service provider gives an account to the user who registered the predetermined personal information. An account name is typically a user's e-mail address, a user's nickname, a character string issued by the SNS service provider. Before using the SNS, the user transmits the account name and the password to the server provided by the SNS service provider. The server provided by the SNS service provider, if determining that there is a match between the incoming account name and password and the registered ones, performs authentication of the user (personal authentication). That is, by transmitting a correct account name and password, the user proves himself/herself to the SNS service provider that he/she is a registered user of the SNS. Hereinafter, the account name and the password are collectively referred to as “login information”.

(Peer Search and Peer Request)

In order to search for a person with whom the user wants to communicate in the SNS, the user generally uses a search system provided by the SNS. The user selects a person with whom the user wants to communicate from among acquaintances found by the search and then sends the person the peer request. In this case, a person to whom the user sent the peer request can reject the peer request. The reasons for the rejection to the peer request can be, for example, that the person to whom the user sent the peer request is a different person with the same name as an intended person, and that the person to whom the user sent the peer request does not want to communicate with the user.

(Invitation)

There is the possibility that the person with whom the user wants to communicate in the SNS is not a member of the SNS. In this case, the user can prompt that person to join the SNS. This is termed “invitation”. The person who has the invitation becomes a user of the SNS by making a registration with the SNS. Users of the SNS can become peers by the method described above. A typical means to invite the person with whom the user wants to communicate is an e-mail, for example. In addition, an easy method to invite many peers can be, for example, a method of inviting a plurality of persons on broadcast according to pieces of contact information registered on a terminal such as a smartphone.

(Communications)

The user is prompted to perform a login required to use the SNS, by the server provided by the SNS service provider. That is, an individual who intends to use the SNS enters the account name and password (login information) registered at the account registration on an input screen (login screen) of the SNS. The server provided by the SNS service provider compares the information managed therein with the login information entered by the user. As a result of the comparison, if the server determines the login information as being correct, the server recognizes the individual as a user. In this manner, the user becomes ready to use the SNS. The user who finds it burdensome to perform the login every time the user uses the SNS can save the login information in the terminal for a certain period of time. This method causes the user's account to be automatically in a logged-in state at the time when the user starts the application required to use the SNS. This eliminates the user having to perform the login every time the user uses the SNS.

For the service provider of such an SNS, it is a common practice to ask the user for consent to the use condition, such as the terms of use and privacy policy, before offering a service. More specifically, the SNS service provider asks the user for a decision as to whether to consent to the use condition, in a situation where the login information, which is one of the pieces of user's personal information, has been authenticated. The user performs an operation to determine whether or not to consent to the use condition, and the terminal used by the user transmits a result of the determination to the SNS service provider. Upon receipt of information indicating the consent to the use condition as a result of the determination from the terminal used by the user, the SNS service provider regards the user as consenting to the use condition and then starts offering the service to the user. As described above, a typical SNS considers, as a prerequisite for offering a service, identifying the user through authentication of the login information and then regarding the user as consenting to the use condition.

Further, Patent Literature 1 describes the invention of a joint purchase of content. In the invention described in Patent Literature 1, a user A solicits users B and C, who are other users, to make a joint purchase of content, on the basis of phone numbers of mobile phones owned by the users B and C. The phone numbers of the mobile phones are different from the login information employed in the typical SNS, but can be said as being user-specific information associated with the personal information of the user.

### CITATION LIST

### Patent Literature

### [Patent Literature 1]

Japanese Patent Application Publication, Tokukai No. 2007-115047 (Publication date: May 10, 2007)

### SUMMARY OF INVENTION

### Technical Problem

The above SNS identifies the user on the basis of the user-specific information associated with the personal information of the user and thus requires every user who uses the SNS to have a high degree of information technology literacy. Such an SNS therefore has the problem that the service offered is not available for easy use by anyone. More specifically the user who uses the SNS is required to (i) register the account to the SNS, to (ii) manage the login information, and to (iii) enter the login information when the user performs the login. If the user loses the login information due to his/her failure in managing the login information, the user cannot log in to the SNS. Further, in a case where leakage of the login information occurs for some reason, a third party may to abuse the SNS by spoofing of the user. Thus, the conventional SNS requires the user to understand the importance of the login information and have information technology literacy to such a degree that the user can manage the login information with safety.

Networking services such as SNS are commonly used, and these services have recently become available for use by means of a shared terminal such as a television. For service providers of these networking services, it is preferable to obtain a user's consent to the use condition before offering a service to the user. Unfortunately, the use of a dedicated terminal (smartphone, etc.) by each user is a prerequisite for most of the networking services. However, even a user who has a low degree of information technology literacy can use the service with the support of his/her family, by means of a television or the like as a shared terminal. The needs for such a use have been increasing. There has not been known a technique for affording facilities for such a user who uses the shared terminal to obtain a user's consent to the use condition of the networking service.

The present invention has been attained to solve the above problem, and an object of the present invention is to provide a server capable of affording facilities to obtain a consent to the use condition of the networking service from the user who uses who uses the networking service, a terminal management method, a terminal, and a storage medium.

### Solution to Problem

In order to solve the above problem, a server according to an aspect of the present invention includes:

a receiving unit configured to receive terminal identification information of a subject terminal, which is a terminal to be registered;

a terminal managing unit configured to manage the terminal identification information of the subject terminal and determining whether or not the terminal identification information of the subject terminal has already been registered; and

a transmitting unit configured to, in a case where the terminal managing unit determines that the terminal identification information of the subject terminal has not already been registered, transmit, to the subject terminal, the following pieces of information:
information for causing the subject terminal to display thereon a first use condition that should be consented to by a user at the registration; and
information for causing the subject terminal to display thereon an acceptance object for accepting a first input indicating a user's consent to the first use condition,

in a case where the receiving unit receives, from the subject terminal, information indicating acceptance of the first input and the terminal identification information of the subject terminal, the terminal managing unit performing a first registration of the terminal identification information of the subject terminal.

In order to solve the above problem, a terminal management method according to an aspect of the present invention includes:

a first reception step of receiving terminal identification information of a subject terminal, which is a terminal to be registered;

a terminal management step of managing the terminal identification information of the subject terminal and determining whether or not the terminal identification information of the subject terminal has already been registered;

a first transmission step of, in a case where it is determined in the terminal management step that the terminal identification information of the subject terminal has not already been registered, transmitting, to the subject terminal, the following pieces of information:
information for causing the subject terminal to display thereon a first use condition that should be consented to by a user at the registration; and
information for causing the subject terminal to display thereon an acceptance object for accepting a first input indicating a user's consent to the first use condition; and

a first registration step of, upon receipt of information indicating acceptance of the first input and the terminal identification information of the subject terminal from the subject terminal, performing a first registration of the terminal identification information of the subject terminal.

In order to solve the above problem, a terminal in accordance with one aspect of the present invention is a terminal adapted to obtain a service offered, in a system for determining whether or not the service is to be offered to the terminal by identifying the terminal before offering the service, the system including a server and at least one terminal, the terminal including:

a sending unit configured to, in making access to the server, send terminal identification information to the server;

a receiving unit configured to, before obtaining the service offered, receive (i) a use condition that should be consented to by a user of the terminal and (ii) an acceptance object for accepting an input indicating a user's consent to the use condition;

a displaying unit configured to display the use condition and the acceptance object, both of which are received by the receiving unit; and

an operating unit configured to make, on the acceptance object, the input indicating the consent,

the sending unit sending, to the server, information indicating that the input indicating the consent has been performed, and then transmitting, to the server, the terminal identification information in making access to the server.

### Advantageous Effects of Invention

According to one aspect of the present invention, it is possible to provide a server capable of affording facilities to obtain a consent to the use condition of the networking service from the user who uses who uses the networking service, a terminal management method, a terminal, and a storage medium.

### BRIEF DESCRIPTION OF DRAWINGS

FIG. 1 is a functional block diagram illustrating the configuration of a server in accordance with Embodiment 1 of the present invention.

FIG. 2 is a view schematically illustrating a SNS system containing the server in accordance with Embodiment 1 of the present invention.

FIG. 3 is a view illustrating the concept of a group established in the SNS system containing the server in accordance with Embodiment 1 of the present invention.

FIG. 4 is a block diagram illustrating an overview of a hardware configuration of the server in accordance with Embodiment 1 of the present invention.

FIG. 5 is a view illustrating an example of a group management table for managing groups in the server in accordance with Embodiment 1 of the present invention.

FIG. 6 is a view illustrating an example of a terminal management table for management of terminals registered with the group on the server in accordance with Embodiment 1 of the present invention.

FIG. 7 is a view illustrating an example of an avatar management table for management of avatars available for use to the terminals registered with the group on the server in accordance with Embodiment 1 of the present invention.

FIG. 8 is a view illustrating an example of a manager's terminal management table for management of a manager's terminal in each group on the server in accordance with Embodiment 1 of the present invention.

FIG. 9 is a view illustrating an example of the group management table further containing a terminal number of the manager's terminal.

FIG. 10 is a view illustrating an example of a message management table for management of messages transmitted from the terminals registered on the server in accordance with Embodiment 1 of the present invention.

FIG. 11 is a sequence diagram showing a flow of a first registration process involved with the SNS offered by the server in accordance with Embodiment 1 of the present invention.

FIG. 12 is a view illustrating a screen shot of a screen displayed by a television, which is the subject terminal to be registered, in the service offered by the server in accordance with Embodiment 1 of the present invention.

FIG. 13 is a functional block diagram illustrating the configuration of a server in accordance with Embodiment 2 of the present invention.

FIG. 14 is a sequence diagram showing a flow of a first registration process involved with the SNS offered by the server in accordance with Embodiment 2 of the present invention.

FIG. 15 is a view illustrating a screen shot of a screen displayed on the mobile terminal, which is the subject terminal to be registered, in the service offered by the server in accordance with Embodiment 2 of the present invention.

FIG. 16 is a functional block diagram illustrating the configuration of a server in accordance with Embodiment 3 of the present invention.

FIG. 17 is a sequence diagram showing a flow of a second registration process involved with the SNS offered by the server in accordance with Embodiment 3 of the present invention.

FIG. 18 is a view illustrating a screen shot of a screen displayed on the manager's terminal in the service offered by the server in accordance with Embodiment 3 of the present invention.

FIG. 19 is a sequence diagram showing a flow of a second registration process involved with the SNS offered by the server in accordance with Embodiment 4 of the present invention.

### DESCRIPTION OF EMBODIMENTS

### Embodiment 1

A social networking service (abbreviated as “SNS”) system 1 in accordance with the present embodiment is a message exchange system aimed at making communications by sharing a message or the like in a group, as a unit, with which a plurality of terminals are registered.

The SNS system 1 is such that terminals, not users, are registered with a group contained in the SNS system 1. Specifically, pieces of terminal identification information (terminal numbers) uniquely given to the terminals used by the users when the users use the SNS system 1 are registered with the group contained in the SNS system 1.

The group contained in the SNS system 1 is a specific group, in which terminals are registered, for giving the registered terminals at least one of a permission to post a message and a permission to view a message. Each of the users who use the SNS system 1 can transmit a message through use of his/her arbitrary terminal registered with the group. This message is transmitted to only the other terminal(s) registered with the group to which the terminal having transmitted the message belongs. In other words, the SNS system 1 does not transmit the message having been transmitted by that terminal, to any terminal outside that group. Conversely, the SNS system 1 does not transmit a message transmitted from any terminal outside that group, to any of the terminals which belong to that group.

Thus, the SNS system 1 is an SNS system that includes groups, each of which is a unit of entity, and has very closed characteristics. The SNS system 1 can exist in the following forms: for example, a family message board system used by family members; and a bulletin board system used to share information among members who belong to one and the same circle. These, however, are not the only possible forms of the SNS system 1.

(Overview of the SNS System 1)

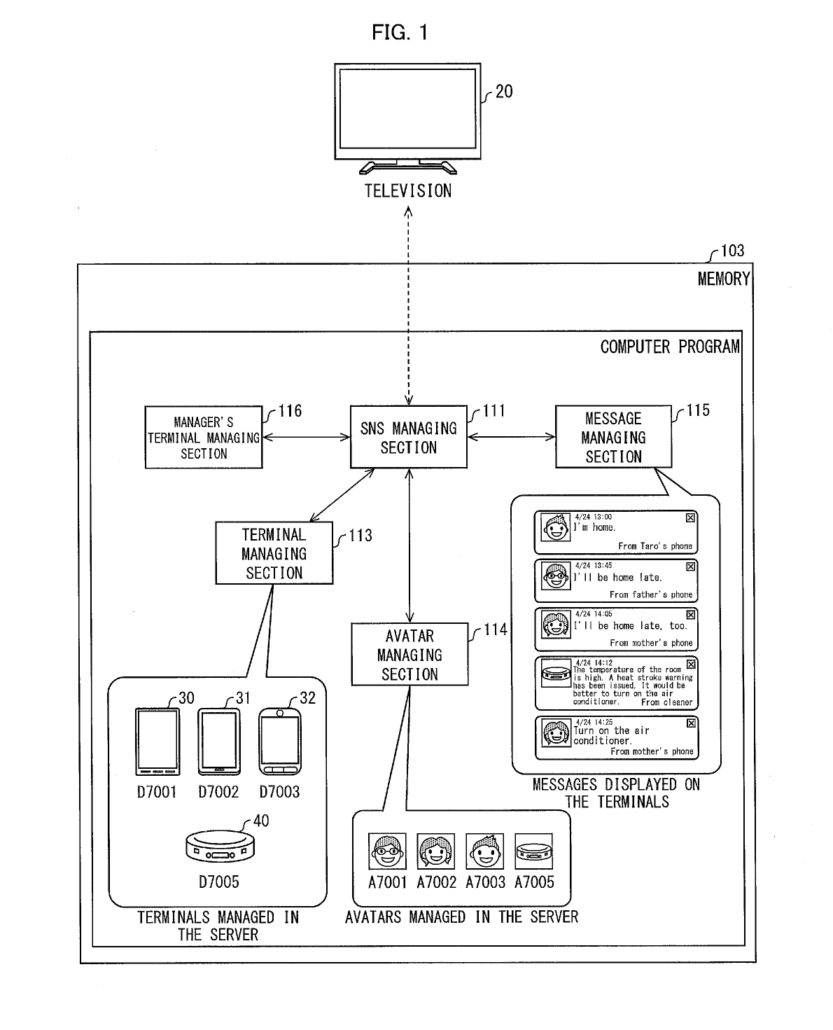

The following will describe overview of the SNS system 1 with reference to FIGS. 1 through 3. FIG. 1 is a functional block diagram of a server 10 that is implemented by a computer program executed through use of a memory 103, which serves as a main storage device, by a control section (CPU) 102 of a server 10 in accordance with Embodiment 1. As illustrated in FIG. 1, the SNS system 1 includes an SNS managing section 111, a group managing section 112, a terminal managing section 113, an avatar managing section 114, a message managing section 115, an manager's terminal managing section 116, an manager's terminal (father's mobile terminal) 30, mobile terminal (mother's mobile terminal) 31, mobile terminal (child's mobile terminal) 32, and a cleaning robot 40. A television 20 is a subject terminal (terminal to be registered) that the father, who is a manager, desires to newly register in the SNS system. The “terminals” in the present embodiment include both mobile terminals, such as a smartphone and a tablet terminal, and stationary terminals, such as a television set and a personal computer. The following will deal with, as a main example, a group named “SATO FAMILY” established in the SNS system 1.

Note that the descriptions in the present embodiment assume that the server 10 is implemented by one (1) apparatus. The form of the server 10, however, is not limited to this form. Alternatively, the server 10 may be constructed by a plurality of apparatuses to which individual functions of the server 10 are assigned.

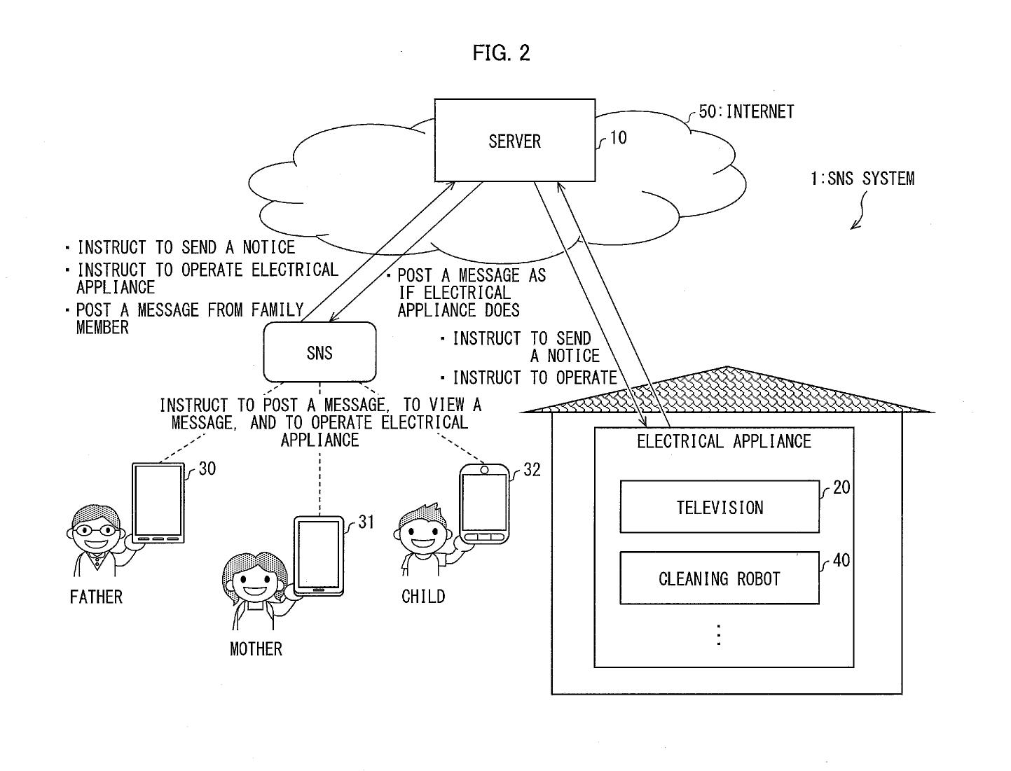

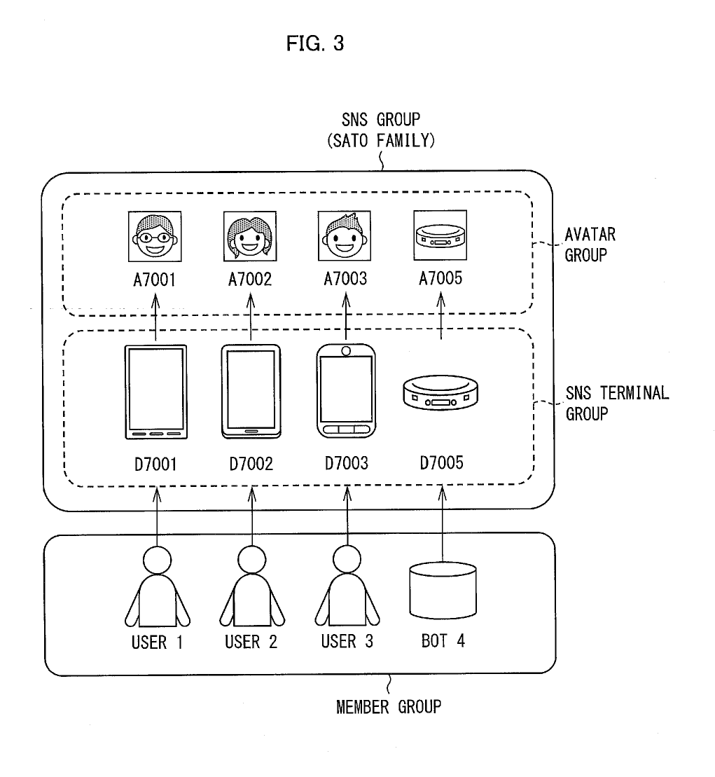

As illustrated in FIG. 3, the “SATO FAMILY”, which is the group contained in the SNS system 1, includes the following four registered terminals: the mobile terminal 30; the mobile terminal 31; the mobile terminal 32; and the cleaning robot 40. In the present embodiment, the television 20 is a subject terminal to be newly registered with the group contained in the SNS system 1. These terminals are connected to the SNS system 1 via an Internet 50, as illustrated in FIG. 2.

FIG. 3 is a view illustrating the concept of a group established in the SNS system 1. The groups established in the SNS system 1 are a terminal group and an avatar group. The terminal group is a group of terminals registered as the group “SATO FAMILY” in the SNS system 1. The SNS system identifies the terminals registered with the group by terminal numbers (in FIG. 3, D7001 through D7005). The “terminal number” as used herein is an identification number unique to each terminal and uniquely given to each terminal. The following will deal with an example case in which the terminal number is used as information for identification of each terminal. In the SNS system 1, however, the information used for identification of each terminal is not limited to the terminal number. Alternatively, a character string or the like information other than a number may be used as the terminal identification information, provided that it allows for identification of each terminal.

The terminal number is preferably a serial number assigned to each terminal before shipment. This, however, is not the only possibility. Alternatively, although details will be described later, a terminal number unique to each terminal may be provided after shipment.

The avatar group is a group of avatars displayed, together with a message, on a display section of a terminal. The avatar is information (symbolic information) representing a sender of a message in a symbolic form and is mainly an image recalling the sender. The avatar is transmitted together with a message to each terminal, so as to make it easy to know who is the sender of that message.

In an example illustrated in FIG. 3, a message transmitted from the mobile terminal 30 assigned with the terminal number D7001 is displayed together with an avatar assigned with an avatar number A7001, which is connected to the terminal number D7001. Similarly, a message transmitted from the mobile terminal 31 assigned with the terminal number D7002 is displayed together with an avatar assigned with an avatar number A7002, which is connected to the terminal number D7002, and a message transmitted from the mobile terminal 32 assigned with the terminal number D7003 is displayed together with an avatar assigned with an avatar number A7003, which is connected to the terminal number D7003. A process of connecting the message, the message, the terminal number, and the avatar number will be described in detail later.

The users who use the SNS system 1 through the use of the mobile terminals 30 to 32 are primarily users specific to the respective mobile terminals. This is because the mobile terminals have a strong tendency to be used exclusively by individuals. Hence, the users who use the SNS system 1 through the use of mobile terminals are often owners of the respective mobile terminals. That is, in many cases, a person who uses the mobile terminal 30 is a user 1 (father), a person who uses the mobile terminal 31 is a user 2 (mother), and a person who uses the mobile terminal 32 is a user 3 (child).

In contrast, the television 20, for example, is a terminal that can be shared among family members. In other words, there is the possibility that all of the family members use the SNS system 1 through the use of the television 20. Note, however, that the television 20 is a subject terminal to be registered in the present embodiment and is not therefore contained in the group “SATO FAMILY” in FIG. 3. The television 20, which is a shared terminal, is likely to be used by at least the following three people: the father; the mother; and the child, who are the family members. In this case, an avatar number connected to a terminal number (e.g. D7004) that represents the television 20 is preferably changed as appropriate according to which user has transmitted a message. In order to realize the above usage form, a correspondence between the terminal number and the avatar number in the SNS system 1 is arranged so as to be changeable as appropriate.

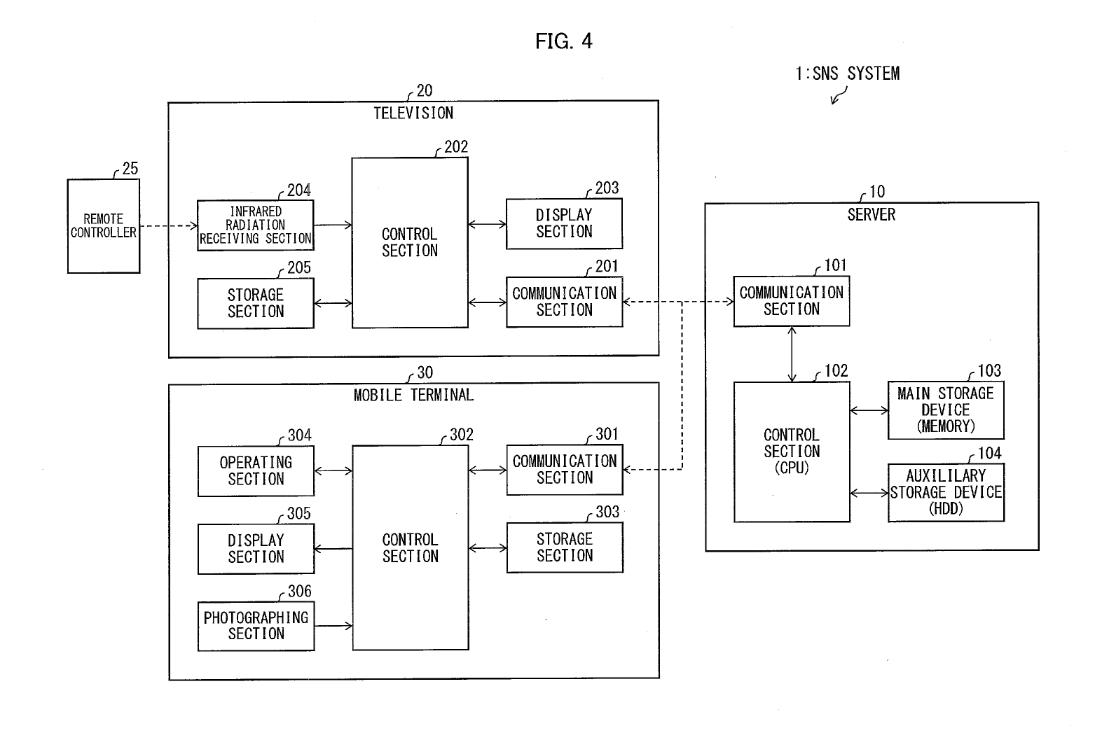

FIG. 4 is a block diagram illustrating an overview of a hardware configuration of the server 10, the television 20, and the mobile terminal 30, all of which are contained in the SNS system 1. As illustrated in FIG. 4, the server 10 includes a communication section 101, a control section 102, a main storage device 103, and an auxiliary storage device 104.

Examples of a device usable as the control section 102 include a CPU (Central Processing Unit). Examples of a device usable as the main storage device 103 include a semiconductor RAM (random access memory). Examples of a device usable as the auxiliary storage device 104 include a hard disk drive (HDD).

The auxiliary storage device 104 stores therein a program for causing the server 10 to operate as a server that offers an SNS. The program contains the SNS managing section 111, the terminal managing section 113, the avatar managing section 114, the message managing section 115, and the manager's terminal managing section 116, all of which have been described earlier.

The control section 102 causes the server 10 to function as a server that offers an SNS, by executing various kinds of instructions which are contained in the program developed on the main storage device 103. More specifically, by executing various kinds of instructions contained in the program, the control section 102 causes the server 10 to function as each of the following sections: an SNS managing section; a terminal managing section; an avatar managing section; a message managing section; and a manager's terminal managing section.

Here, the SNS managing section, the terminal managing section, the avatar managing section, the message managing section, and the manager's terminal managing section perform operations similar to the operations performed by the SNS managing section 111, the terminal managing section 113, the avatar managing section 114, the message managing section 115, and the manager's terminal managing section 116.

(Television 20)

The television 20, which is a subject terminal, includes a communication section 201, a control section 202, a display section 203, an infrared radiation receiving section 204, and a storage section 205. Further, a user of the television 20 can control operations of the television 20 through the use of a remote controller 25.

The communication section 201 is configured to be capable of communications with the server 10 through a LAN and the Internet. The control section 202 performs centralized control of the communication section 201, the display section 203, the infrared radiation receiving section 204, and the storage section 205, which are included in the television 20.

A program provided by the server 10 is installed on the television 20 so that the user can use the SNS.

(Mobile Terminal)

The mobile terminal includes a communication section 301, a control section 302, a storage section 303, an operating section 304, a display section 305, and a photographing section 306. Here, the mobile terminal 30 is taken as an example of the mobile terminal although the mobile terminal 31 and the mobile terminal 32 are configured similarly to the mobile terminal 30.

A mobile terminal owned by a user who is a manager is also referred to as “manager's terminal”. In the present embodiment, the mobile terminal 30 is a mobile terminal owned by the father who is the manager of the group and is also referred hereinafter to as “manager's terminal 30”. On the other hand, the mobile terminals owned by the users (the mother and the child) who are not the manager are referred to as the mobile terminals 31 and 32 for the sake of distinction from the manager's terminal 30.

There are, however, no differences between the manager's terminal and the mobile terminal in terms of hardware configuration. More specifically, the mobile terminals 31 and 32, as in the manager's terminal 30, each include the communication section 301, the control section 302, the storage section 303, the operating section 304, the display section 305, and the photographing section 306.

The communication section 301 is configured to be capable of communications with the server 10 through a telephone network, the Internet, or the like network. The control section 302 performs centralized control of the communication section 301, the storage section 303, the operating section 304, the display section 305, and the photographing section 306, which are included in the mobile terminal 30.

A program provided by the server 10 is installed on the mobile terminal 30 so that the user can use the SNS.

(Registration of Electrical Appliance)

A terminal to be registered in the group of the SNS system 1 is not necessarily a mobile terminal such as a smartphone or an information display terminal such as a television, but may be an electrical appliance. An electrical appliance to be registered with the group is anthropomorphized within the group. In the present embodiment, electrical appliances that can be registered in the group are, for example, electrical appliances operable by voice and electrical appliances that enable communications with the user.

These electrical appliances often include a sensor that enables monitoring of a room temperature, a humidity, or the like. The SNS system 1 may be arranged such that the electrical appliance registered with the group of the SNS system 1 obtains environment information from each sensor and then supplies the environment information to an external server, and the external server transmits a message appropriate to the environment information thus obtained as if the electrical appliance transmits that message. In FIG. 3, a bot 4 contained in a member group obtains environment information from its corresponding electrical appliance and then transmits a message appropriate to that environment information as if the anthropomorphized electrical appliance transmits that message.

With the arrangement in which such an electrical appliance can be registered in the SNS system 1, it is possible for the SNS system 1 to provide the following noble usage forms of the electrical appliance:

(i) In a case where the user wishes to make his/her room comfortable before the user gets home, the user may operate his/her mobile terminal to transmit a message providing an instruction reflecting the user's wish. With this arrangement, it is possible for an electrical appliance contained in the group to control, upon receipt of that message, an air condition of the room so that the room becomes comfortable before the user gets home.

(ii) While the family members are out, only a pet stays in the home. In this situation, even if a temperature in the room increases with increasing outside-air temperature, the pet is unable to turn on the air conditioner or to contact any of the family members. In such a case, the electrical appliance in the group can provide, to the terminals of the family members, a notification about the increased temperature in the room through the SNS system 1. Upon receipt of the notification from the electrical appliance, the family members can consult with each other about what action to take through the SNS system 1. Alternatively, by controlling the electrical appliance through the SNS system 1, any one of the family members can turn on the air conditioner. In this case, the family members can ascertain, through the SNS system 1, what action has been taken by whom of the family members.

Unfortunately, the conventional SNS system does not have any method of obtaining a user's consent about his/her use of the SNS system at the registration of an electrical appliance with the SNS system. For this reason, the conventional SNS system makes it difficult to realize the aforementioned usage forms specific to the present embodiment. In contrast, the SNS system 1 allows an electrical appliance to be registered in the SNS system and therefore makes it possible to realize the aforementioned usage forms.

The descriptions in the present embodiment take the cleaning robot 40 as an example of the anthropomorphized electrical appliance. The anthropomorphized electrical appliance, however, is not limited to the cleaning robot 40 and can be various kinds of appliances within a home, such as an air conditioner, a refrigerator, and a washing machine.

(Configuration of the Server 10)

With reference to FIG. 1, the following will describe the configuration of the server 10.

(SNS Managing Section 111)

The SNS managing section 111 is a control block for managing and operating the overall server 10. As illustrated in FIG. 1, the terminals using the server 10 are connected to the SNS managing section 111 via the Internet 50. That is, the SNS managing section 111 is a server that serves as a window in the SNS system 1. For example, the SNS managing section 111 generates a time-line screen of posted messages to be displayed on the terminals and then transmits the time-line screen to the terminals.

(Group Managing Section 112)

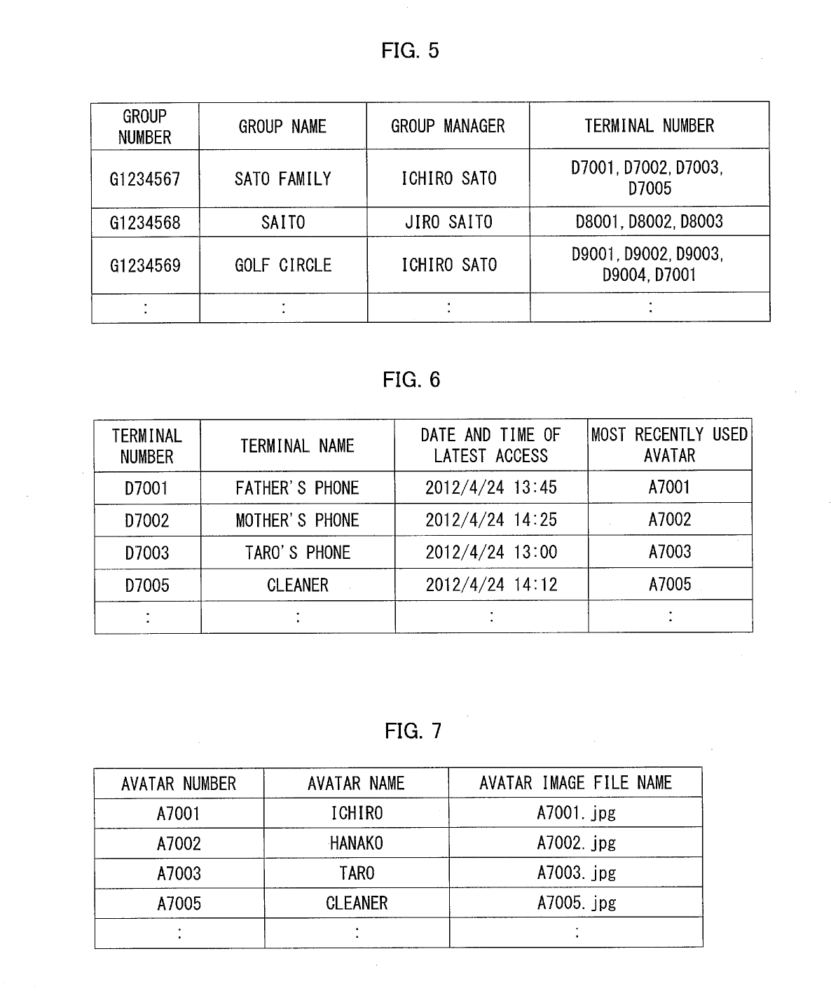

The group managing section 112 is a control block for managing groups each of which is a unit of entity in which a message is shared in the SNS system 1. Although not illustrated in FIG. 1, the group managing section 112 may be included in the server 10. FIG. 5 is a view illustrating an example of a group management table for managing groups in the server 10. The group management table is stored in a storage section which is included in the group managing section 112.

In the server 10, a plurality of groups are generated. As illustrated in FIG. 5, the group management table contains, for each group, the following items: a group number given to the group for identification; a group name; a group manager; terminal numbers of terminals registered with the group. All of these items are associated with each other in the group management table.

More specifically, as for a group given G1234567 as the group number, the group name is SATO FAMILY, the group manager is Mr. ICHIRO SATO, and the unique terminal numbers registered are D7001, D7002, D7003, and D7005. As for a group given G1234568 as the group number, the group name is SAITO, the group manager is Mr. JIRO SAITO, and the unique terminal numbers registered are D8001, D8002, and D8003. As for a group given G1234569 as the group number, the group name is GOLF CIRCLE, the group manager is Mr. ICHIRO SATO, and the unique terminal numbers registered are D9001, D9002, D9003, D9004, and D7001.

In the present embodiment, an upper limit may be set on the number of terminals that can be registered in each of the groups. This can be realized by setting an upper limit on the number of terminal numbers that can be associated with each of the group numbers. Further, in the present embodiment, one and the same terminal can be registered in different groups. This can be realized by registering one (1) terminal number in the group management table so as to be associated with different group numbers.

(Terminal Managing Section 113)

The terminal managing section 113 is a control block for managing, for each group, all of the terminals registered in that group. FIG. 6 is a view illustrating an example of a terminal management table for management of terminals registered with the group on the server 10. The terminal management table is stored in a storage section (not illustrated) which is included in the terminal managing section 113. FIG. 6 shows the terminal management table regarding the terminals registered with the group given the group number “G1234567”.

The terminal management table contains, for each terminal registered in a group, the following items: a terminal number of the terminal; a name of the terminal; a date and time of a latest access to the server 10 by the terminal; an avatar number of an avatar used at a latest message transmission made by the terminal.

(Avatar Managing Section 114)

The avatar managing section 114 is a control block for managing, for each group, avatars available for use to the terminals registered with the group. FIG. 7 is a view illustrating an example of an avatar management table for management of avatars available for use to the terminals registered with the group on the server 10. The avatar management table is stored in a storage section (not illustrated) which is included in the avatar managing section 114. FIG. 7 shows the avatar management table for management of avatars available for use to the terminals registered with the group given the group number “G1234567”.

The avatar management table contains, for each avatar, the following items: an avatar number unique to the avatar; a name of the avatar; and a file name of an avatar image. Data of the avatar image is stored in the storage section of the avatar managing section 114.

(Manager's Terminal Managing Section 116)

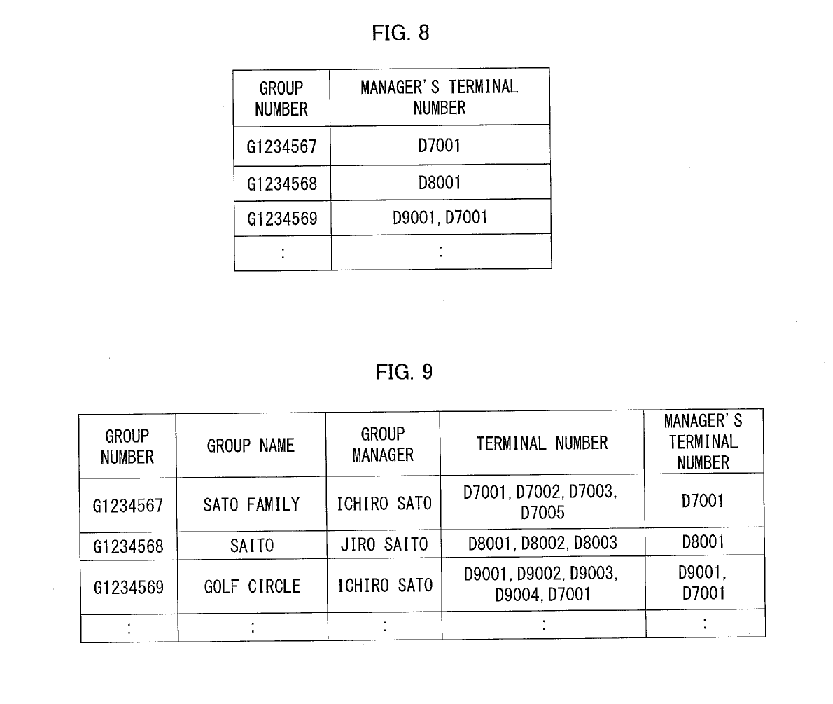

The manager's terminal managing section 116 is a control block for managing, in each group in the SNS system 1, which of the terminals registered with the group is a manager's terminal. FIG. 8 is a view illustrating an example of a manager's terminal management table for management of a manager's terminal in each group on the server 10. The manager's terminal management table is stored in a storage section (not illustrated) which is included in the manager's terminal managing section 116.

In the server 10, a plurality of groups are generated. As illustrated in FIG. 8, the manager's terminal management table contains, for each group, the following items: a group number given for identification of the group; and a terminal number of a manager's terminal. All of these items are associated with each other in the manager's terminal management table.

In the present embodiment, a plurality of manager's terminals can be registered for each of the groups. This can be realized by registering terminal numbers of a plurality of manager's terminals in a field of the manager's terminal number corresponding to the group number in the manager's terminal management table.

In the server 10, the group managing section 112 and the manager's terminal managing section 116 may be integrated with each other. That is, the group managing section 112 may double as the manager's terminal managing section 116. In this case, group management table further contains the terminal number(s) of the manager's terminal(s) and used for management of the groups. FIG. 9 is a view illustrating an example of the group management table further containing the terminal number(s) of the manager's terminal(s). The group management table illustrated in FIG. 9 is a table into which the group management table illustrated in FIG. 5 and the manager's terminal management table illustrated in FIG. 8 are integrated.

The following descriptions assume that the group managing section 112 doubles as the manager's terminal managing section 116. Accordingly, the group managing section 112 uses the group management table in the form illustrated in FIG. 9 to ascertain whether or not a terminal making access to the server 10 is the manager's terminal.

(Message Managing Section 115)

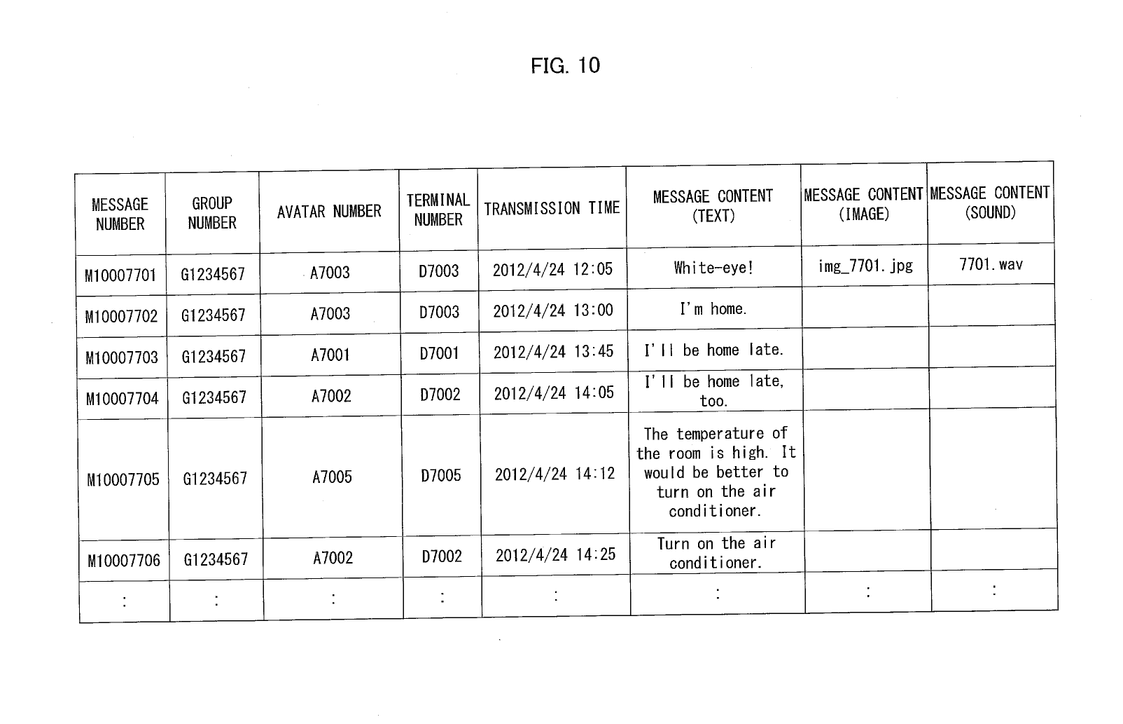

The message managing section 115 is a control block for managing messages transmitted from the terminals registered in the server 10. FIG. 10 is a view illustrating an example of a message management table for management of messages transmitted from the terminals registered on the server 10. The message management table is stored in a storage section (not illustrated) which is included in the message managing section 115.

In the server 10, information as to a message transmitted by each of the terminals is managed for each message in the message management table. In an example shown in FIG. 10, the message management table contains, for each message, the following items: a message number given to the message for identification; a group number of a group to which a terminal transmitting the message belongs; an avatar number given to an avatar for identification of an avatar used at the transmission of the message; a terminal number of a terminal transmitting the message; a date and time of transmission of the message; and a content (at least one of a text, an image, and a voice) of the message. All of these items are associated with each other in the message management table.

Every time each of the terminals transmits a new message, information as to that message is accumulated in the message management table. How to deliver a message to a destination terminal of the message by using the message management table will be described in detail later.

(Group Establishment)

The server 10 allows a user who has made user registration on the server 10 to establish the aforementioned group. The following will describe a procedure of how a user who has registered into the server 10 constructs a group in the SNS system 1.

First of all, a user who wants to establish a group makes use registration on the server 10. This user registration is performed by the same procedure as the procedure taken to make new user registration through the conventional service or to set up an account through the conventional service. That is, the user registration is made by signing up for an identifier (account) and a password, both of which are used to identify a user, with the server 10 and further registering user's personal information. Note that user registration may be performed using an account that has already been used for another service. The user who has made user registration on the server 10 is given a special permission to establish a group. In the following descriptions, a user who establishes a group will be referred to as a “representative”.

The representative logs in to the server 10 using the manager's terminal 30 and then requests the server 10 to establish a new group. At that time, the representative enters a group name and other information as to the new group. Further, the manager's terminal 30 offers, to the server 10, a terminal number of the manager's terminal 30. In this manner, the group is established. At that time, the manager's terminal 30 of the representative is automatically registered in the newly established group. That is, the terminal number of the manager's terminal 30 is registered in the group management table so as to be associated with the group number of the newly established group. In the following procedure, the representative also serves as a manager of the group.

Upon completion of the establishment of the group, the server 10 offers, to the manager's terminal 30, a group number of the newly established group. This means that the manager's terminal 30 holds both the terminal number of the manager's terminal 30 and the group number of the group.

(Other Remarks)

In a typical SNS system, each user registers, with the SNS system, his/her personal information required to use the SNS system and then obtain his/her own account. In contrast, the SNS system 1 described in Embodiment assumes that there exist no user-specific accounts (although an account provided for a manager of each group is an exception). This, however, is not the only possibility. The SNS system 1 can also be used in a situation where an account is obtained for each user.

(First Registration Process Involved with the SNS)

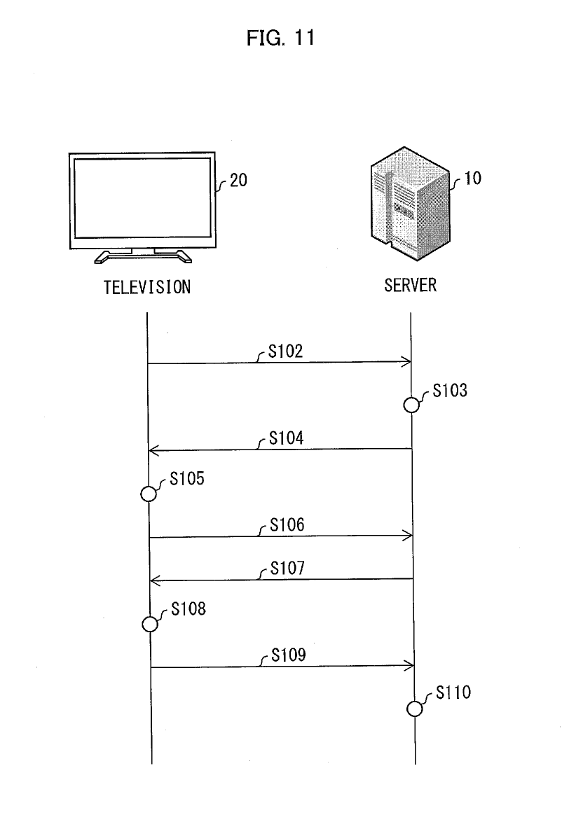

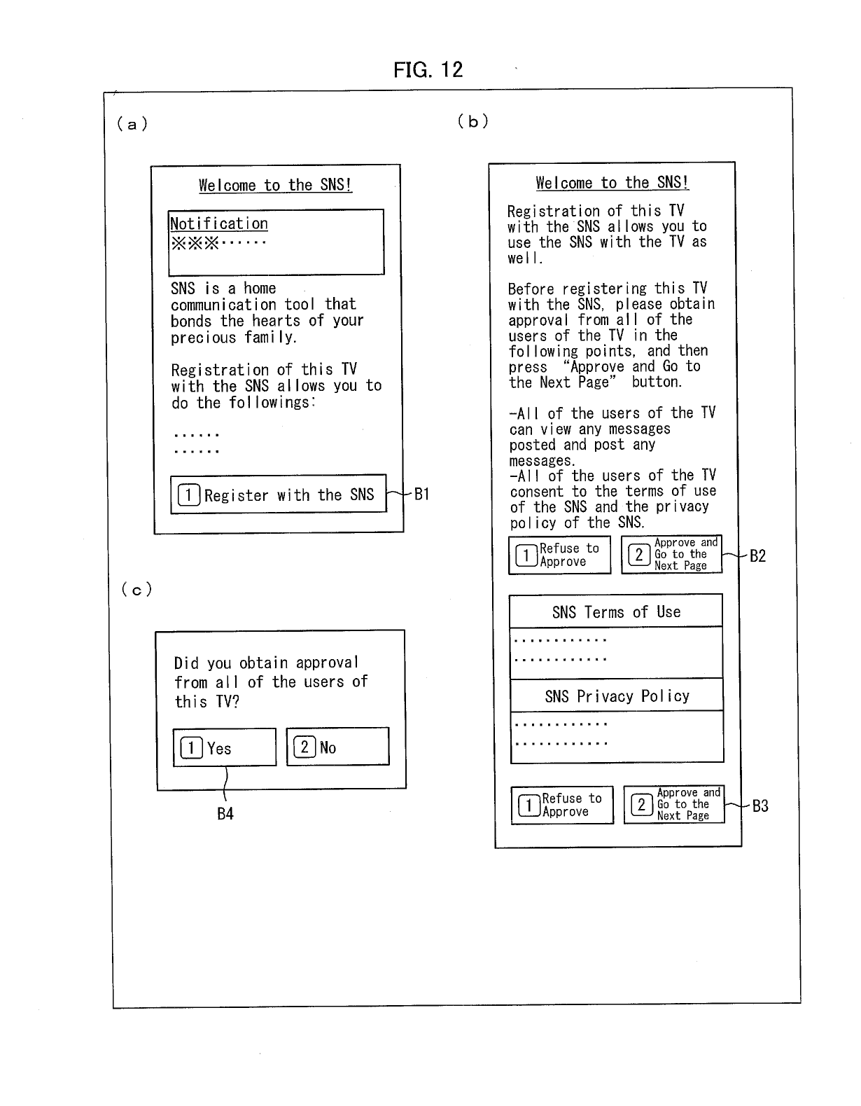

The following will describe the processes involved with the SNS offered by the server 10 in the SNS system 1, with reference to FIGS. 11 and 12. FIG. 11 is a sequence diagram showing a flow of a first registration process for making first registration of a terminal in all of the processes involved with the SNS offered by the server 10. FIG. 12 is a view illustrating a screen shot of a screen displayed by the television 20, which is the subject terminal to be registered, during the first registration process.

In Step S102, the control section 202 of the television 20, which is the subject terminal to be registered, makes access to the server 10 to use the SNS. More specifically, in a case where an icon for using the SNS is selected by an operation made through the remote controller 25 on a menu screen displayed on the display section 203, the control section 202 transmits, to the server 10, at least (a) a signal indicative of the intention to use the SNS and (b) terminal identification information of the television 20. The SNS managing section 111 of the server 10 receives, via the communication section 101, the (a) signal indicative of the intention to use the SNS and the (b) terminal identification information of the television 20. Thus, the SNS managing section 111 can be said to be receiving unit.

In Step S103, the terminal managing section 113, which serves as the terminal managing unit, determines whether or not the terminal identification information of the television 20 has already been registered on the server 10.

In Step S104, if the terminal managing section 113 determines that the terminal identification information of the television 20 has not already been registered on the server 10, the SNS managing section 111 transmits, to the television 20, a signal indicative of an instruction to display a screen illustrated in (a) of FIG. 12 on the display section 203 of the television 20.

In Step S105, upon receipt of the signal indicative of the instruction, the control section 202 of the television 20 causes the display section 203 to display thereon the screen illustrated in (a) of FIG. 12. On the screen illustrated in (a) of FIG. 12, when the father, who is the manager of the SNS group, selects a button B1 saying “Register with the SNS”, the remote controller 25 transmits, to the television 20, a signal indicative of an instruction to initiate the first registration process required to use the SNS. The control section 202 receives the signal indicative of the instruction to initiate the first registration process. Note that, even when the father selects “1” on the screen illustrated in (a) of FIG. 12 by pushing “1” on a ten-key numeric pad of the remote controller 25, the remote controller 25 can transmit, to the television 20, the signal indicative of the instruction to initiate the first registration process.

In Step S106, the control section 202 transmits, to the server 10, a signal indicative of the instruction to initiate the first registration process.

In Step S107, upon receipt of the signal indicative of the instruction to initiate the first registration process, the SNS managing section 111 transmits, to the television 20, the following pieces of information (i) and (ii):

(i) information for causing the television 20 to display thereon terms of use that should be consented to by the user at the registration (first use condition that should be consented to by the user at the registration); and
(ii) information for causing the television 20 to display thereon a button (acceptance object) for accepting an input from the user when the user consents to the terms of use. Thus, the SNS managing section 111 can be said to be transmitting unit.

Here, the (i) information for causing the television 20 to display thereon terms of use that should be consented to by the user at the registration may be data itself representing the terms of use or may be a link to a web page for displaying the terms of use. The (ii) information for causing the television 20 to display thereon a button for accepting an input from the user when the user consents to the terms of use may be information for selecting a relevant button from among a plurality of buttons. As to the (ii) information to cause the television 20 to display thereon the acceptance object for accepting an input from the user when the user consents to the terms of use, the acceptance object may be a button icon, a checkbox with a statement indicating a user's consent to the terms of use, or a combination of the button icon and the checkbox.

In the present embodiment, the first use condition refers to at least one of (a) the terms of use and (b) privacy policy. In a case where the first use condition refers to the terms of use, a second use condition refers to the privacy policy. In a case where the first use condition refers to both the (a) terms of use and the (b) privacy policy, the second use condition refers to the privacy policy.

In Step S108, when the television 20 receives the information (i) and information (ii), the control section 202 of the television 20 causes the display section 203 to display thereon the screen illustrated in (b) of FIG. 12. The screen illustrated in (b) of FIG. 12 contains the terms of use, entitled “Terms of Use of the SNS”, that should be consented to (approved) by the user and buttons B2 and B3 saying “Approve and Go to Next Page”. In the present embodiment, the buttons B2 and B3 are the acceptance objects for accepting an input indicating a user's consent to the terms of use. The user who consents to the terms of use can input, to the television 20, the consent to the terms of use by selecting the button B2 or B3 through the operation of the remote controller 25. Instead of selecting the button B2 or B3, the user can input, to the television 20, the consent to the terms of use by pushing “2” on the ten-key numeric pad of the remote controller 25.

The television 20 is a terminal shared by a plurality of users, typified by family members (e.g. father, mother, and child as illustrated in FIG. 2), living together in the same house. Then, in the SNS offered by the server 10, the father who has selected the button B2 or B3 is prompted to obtain consent from all of the users of the television and then select the button B2 or B3 (see (b) of FIG. 12). Further, in a case where the television 20 accepts the input indicating the father's consent to the terms of use from the father, the control section 202 may cause the display section 203 to display thereon the screen illustrated in (c) of FIG. 12 to check with the user about whether or not all of the users of the television 20 have consented to the terms of use. Then, the father selects a button B4 saying “Yes” to proceed with the first registration process.

In a case where a service provider of the SNS obtains such an input indicating the user's consent to the terms of use that should be consented to by the user, the service provider can regard all of the users of the television 20 as consenting to the terms of use.

Note that the screen that the control section 202 causes the display section 203 to display thereon at that time may contain “SNS Privacy Policy” as illustrated in (b) of FIG. 12. The “SNS Privacy Policy” is the second use condition that should be consented to by the user at the registration.

In Step S109, when the television 20 accepts the input indicating the consent to the terms of use from the user through the button B2 or B3 (acceptance object), the control section 202 causes the communication section 201 to transmit, to the server 10, (a) information indicating the acceptance of the input indicating the consent to the terms of use and (b) the terminal identification information of the television 20.

In Step S110, in a case where the SNS managing section 111 of the server 10 receives, from the television 20, (a) the information indicating the acceptance of the input indicating the consent to the terms of use and (b) the terminal identification information of the television 20, the terminal managing section 113 performs first registration of setting the terminal identification information of the television 20 as the terminal identification information of the terminal that is permitted to be registered. By completing the first registration process, the server 10 achieves the objective of obtaining the consent from the user who uses the subject terminal. As a result, the television 20, which is the subject terminal to be registered, becomes a registered terminal in the SNS group, so that the television 20 can use the SNS.

Note that the television 20 in accordance with the present embodiment is an example of a terminal that can obtain a service (SNS) offered by a system (SNS system 1) which offers the service to a terminal registered on the server 10.

The television 20 as an example of such a terminal includes a sending unit, a receiving unit, a displaying unit, and an operating unit. In making access to the server 10, the control section 202, which serves as the sending unit, transmits, to the server 10, the terminal identification information of the television 20. The control section 202, which serves as the receiving unit, receives, prior to obtaining a service of the SNS, the use condition that should be consented to by the user of the television 20 and the acceptance object for accepting the input indicating the user's consent to the use condition. The display section 203, which serves as the displaying unit, displays thereon the use condition and the acceptance object, both of which are received by the control section 202. The remote controller 25 serves as the operating unit to perform an input indicating the consent to the acceptance object. The control section 202, which serves as the sending unit, transmits, to the server 10, information indicating that the input indicating the consent has been performed. Thereafter, in making access to the server 10, the control section 202 transmits, to the server 10, the terminal identification information of the television 20.

The control section 202 causes the television 20 to function as a terminal using the SNS by executing various kinds of instructions that are contained in a program developed on the storage section 205. More specifically, the control section 202 causes the television 20 to function as the sending section (sending unit) and the receiving section (receiving unit) by executing various kinds of instructions contained in the program.

### Embodiment 2

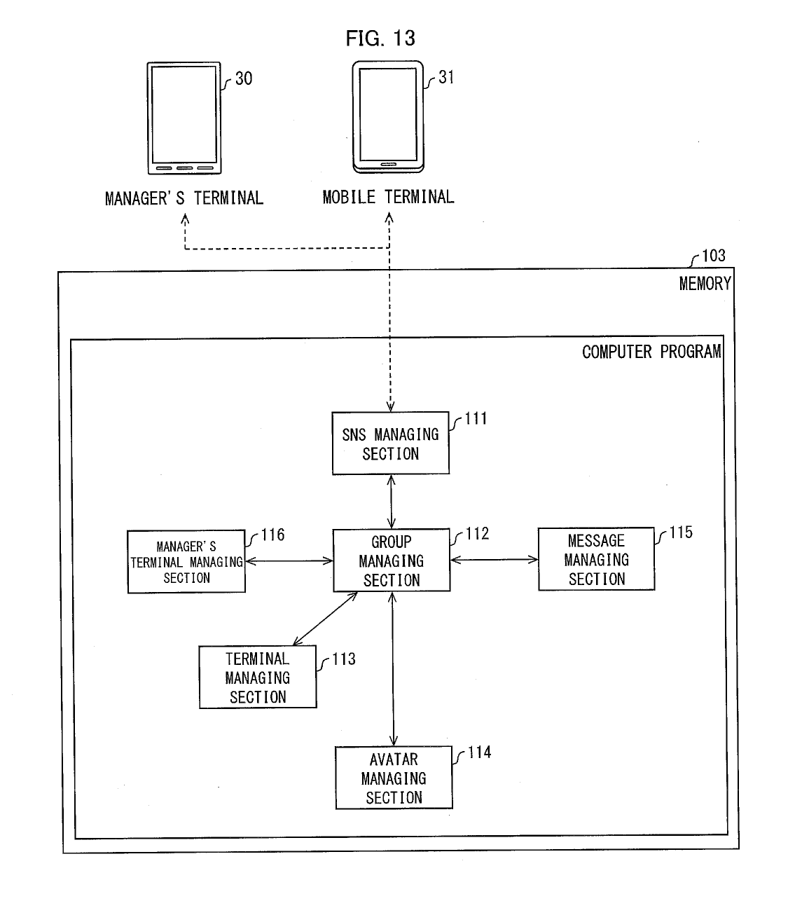

The following will describe Embodiment 2 of the present invention with reference to FIGS. 13 through 15. For convenience of explanation, members of Embodiment 2 that are identical in function to their respective corresponding members described in Embodiment 1 are each assigned a common reference numeral, and are not described here.

FIG. 13 is a functional block diagram illustrating the configuration of the server 10 in accordance with the present embodiment. The server 10 in accordance with the present embodiment is different from the server 10 in accordance with Embodiment 1 in that the server 10 in accordance with the present embodiment further includes the group managing section 112, which serves as a group managing unit. As described earlier, the group managing section 112 manages groups each of which is a unit of entity in which a message is shared in the SNS system 1.

The SNS managing section 111 of the server 10 is configured to perform wireless communications with the manager's terminal 30 and the mobile terminal 31, which is a subject terminal to be registered, through the communication section 101.

(First Registration Process Involved with the SNS)

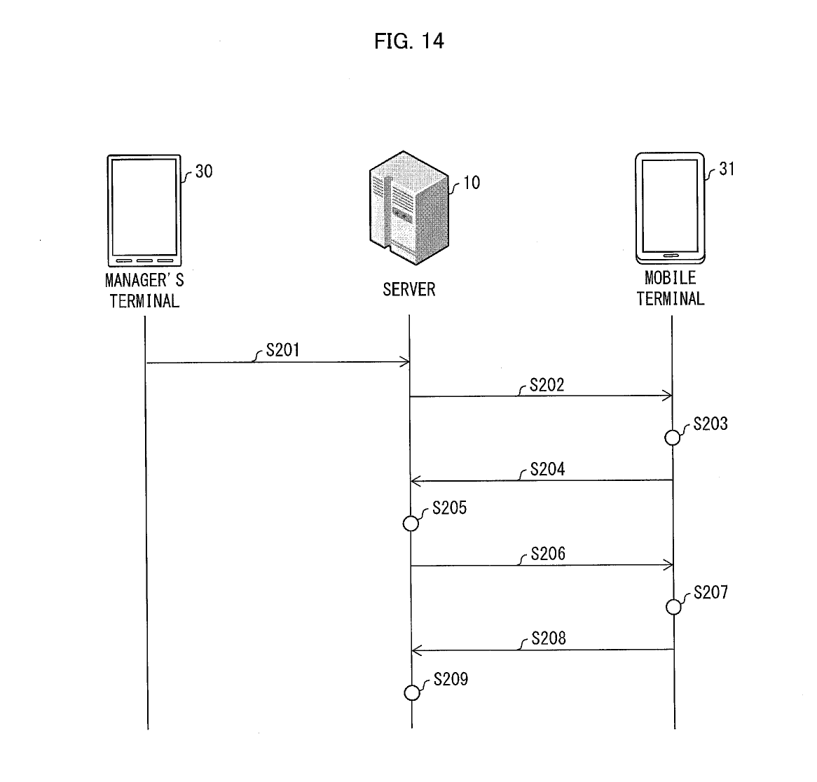

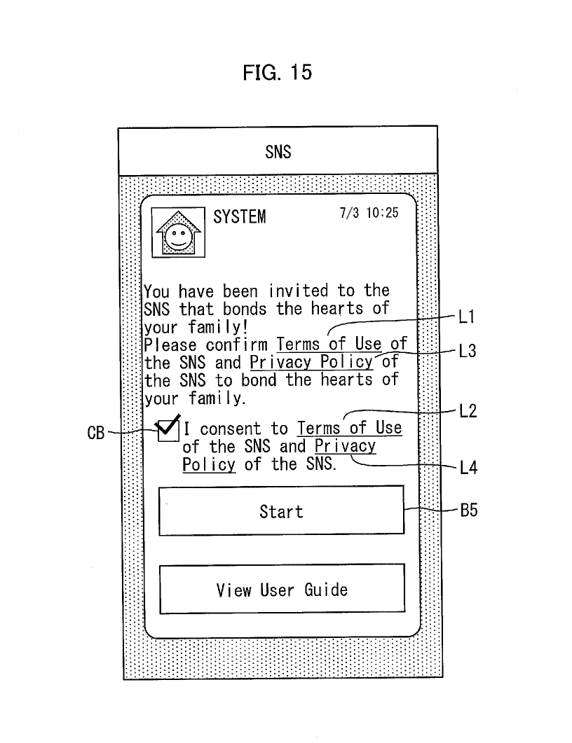

The following will describe the processes involved with the SNS offered by the server 10, with reference to FIGS. 14 and 15. FIG. 14 is a sequence diagram showing a flow, of the first registration process for making first registration of a mobile terminal in all of the processes involved with the SNS offered by the server 10. FIG. 15 is a view illustrating a screen shot of a screen displayed on the mobile terminal 31, which is the subject terminal to be registered, during the first registration process. The descriptions in the present embodiment assume that the manager's terminal 30 is the father's phone (terminal identification information: D7001), and the subject terminal to be registered (mobile terminal 31) is the mother's phone (terminal identification information: D7002).

In the present embodiment, the first registration process is initiated when the manager's terminal 30 newly invites the mobile terminal 31 to be newly registered in the SNS group.

In Step S201, the manager's terminal 30 of the father, who is the manager of the group, transmits, to the server 10, a terminal invitation instruction for newly inviting the mobile terminal 31, which is the subject terminal to be registered. The terminal invitation instruction contains (a) the terminal identification information of the mobile terminal 31 and (b) the group identification information G1234567 of the group to which the mobile terminal 31 is to be invited. The group to which the manager's terminal 30 is permitted to invite the mobile terminal 31 to belong is any one of the groups to which the manager's terminal 30 belongs. Thus, it can be said that the terminal invitation instruction contains group identification information of a group to which a manager's terminal belongs.

Further, in order to invite the mobile terminal 31, the terminal invitation instruction contains specification information for specifying the mobile terminal 31. Examples of the specification information encompass an e-mail address that can be viewed by means of the mobile terminal 31 and a phone number of the mobile terminal 31. The descriptions in the present embodiment assume that the manager's terminal 30 is arranged to invite the mobile terminal 31 by using an electronic mail, and an e-mail address is employed as the specification information. The manager's terminal 30, however, may be arranged to invite the mobile terminal 31 by using any other message transmission/reception function. The terminal invitation instruction may further contain the terminal identification information D7002 of the mobile terminal 31.

In Step S202, the SNS managing section 111, which serves as the receiving unit, receives, from the manager's terminal 30, (a) the terminal identification information of the mobile terminal 31 and (b) the group identification information G1234567 of the group to which the mobile terminal 31 is to be invited. The group managing section 112 of the server 10 manages the terminal identification information D7002 of the subject terminal and the group identification information G1234567 of the group which the subject terminal is to be registered to join, both of which information are received by the SNS managing section 111, in such a manner that the terminal identification information D7002 and the group identification information G1234567 are associated with each other.

Upon receipt of the terminal invitation instruction from the manager's terminal 30, the server 10 transmits, to an e-mail address as the specification information, an invitation mail indicating an invitation to the SNS group. The invitation mail contains a link to a web page from which to download an application required to use the SNS (hereinafter referred to as “SNS application”).

In Step S203, upon receipt of the invitation mail, a control section of the mobile terminal 31 causes a display section of the mobile terminal 31 to display thereon the invitation mail. The mother, if wishing to register the mobile terminal 31 with the group which the mobile terminal 31 is to be registered to join, follows the link contained in the invitation mail to download and install the SNS application to and onto the mobile terminal 31.

In Step S204, the control section of the mobile terminal 31 transmits, to the server 10, (1) the terminal identification information D7002 of the mobile terminal 31 and (2) the group identification information G1234567 of the group which the mobile terminal 31 is to be registered to join, through the installed SNS application.

In Step S205, the SNS managing section 111 (receiving unit) of the server 10 receives, from the mobile terminal 31, the terminal identification information D7002 and the group identification information G1234567 of the group which the mobile terminal 31 is to be registered to join.

In Step S206, the terminal managing section 113 of the server 10 determines whether or not the terminal identification information D7002 of the mobile terminal 31 has already been registered on the server 10. In a case where the terminal managing section 113 determines that the terminal identification information D7002 has not already been registered, the SNS managing section 111 transmits, to the mobile terminal 31, an invitation notification containing a notification that a permission for the invitation of the mobile terminal 31 to the SNS is granted. The invitation notification contains not only the notification that the permission for the invitation of the mobile terminal 31 to the SNS is granted but also the following pieces of information (i) through (iii):

(i) information for causing the mobile terminal 31 to display thereon terms of use that should be consented to by the user at the registration to the SNS (first use condition that should be consented to by the user at the registration);
(ii) information for causing the mobile terminal 31 to display thereon an acceptance object for accepting an input from the user when the user consents to the terms of use; and
(iii) information for causing the mobile terminal 31 to display thereon a privacy policy that should be consented by the user at the registration to the SNS (second use condition that should be consented to by the user at the registration).

In Step S207, when the mobile terminal 31 receives the invitation notification, the control section of the mobile terminal 31 causes the display section to display thereon a screen illustrated in FIG. 15. The screen illustrated in FIG. 15 contains not only a text indicating a grant of the permission for the invitation to the SNS, i.e. “You have been invited to the SNS that bonds the hearts of your family!”, but also the links L1 and L2, which are the information (i). When the user (mother) of the mobile terminal 31 selects any one of the links L1 and L2, the terms of use that should be consented by the user at the registration to the SNS (first use condition that should be consented to by the user at the registration) are displayed on the mobile terminal 31 so that the user of the mobile terminal 31 can read the terms of use.

The screen illustrated in FIG. 15 further contains the links L3 and L4, which are the information (iii). When the mother selects any one of the links L3 and L4, the privacy policy that should be consented by the user at the registration to the SNS (second use condition that should be consented to by the user at the registration) are displayed on the mobile terminal 31 so that the mother can read the privacy policy.

The screen illustrated in FIG. 15 still further contains a checkbox CB, which is the information (ii), and a button B5 saying “Start”. The mother who has an intention to consent to the terms of use displayed upon selecting any of the links L1 and L2 can input, to the mobile terminal 31, the consent to the terms of use by placing a checkmark in the checkbox CB with the statement saying “I consent to Terms of Use of the SNS” and then tapping the button B5.

As described above in the present embodiment, the acceptance object for accepting an input from the user is constituted by a combination of the checkbox and the button. This means that the mother is required to perform the two steps when she inputs, to the mobile terminal 31, the consent to the terms of use of the SNS. With this arrangement, the mother who inputs, to the mobile terminal 31, the consent to the terms of use of the SNS can be regarded by the service provider of the SNS as doing the input with a clear indication of the intention to consent to the terms of use.

Note that the screen displayed by selecting any one of the links L1 and L2 may contain not only the terms of use, which is the first use condition, but also the privacy policy, which is the second use condition.

In Step S208, when the mobile terminal 31 accepts the input indicating the consent to the terms of use from the user through the checkbox CB and the button B5, the control section of the mobile terminal 31 transmits, to the server 10, (a) information indicating the acceptance of the input indicating the consent to the terms of use and (b) the terminal identification information D7002 of the mobile terminal 31.

In Step S209, in a case where the SNS managing section 111 of the server 10 receives, from the mobile terminal 31, (a) the information indicating the acceptance of the input indicating the consent to the terms of use and (b) the terminal identification information D7002 of the mobile terminal 31, the terminal managing section 113 performs the first registration of the terminal identification information D7002 of the mobile terminal 31 in such a manner that the terminal identification information D7002 of the mobile terminal 31 is associated with the group identification information G1234567 of the group to which the manager's terminal 30 belongs. Specifically, the terminal managing section 113 makes an inquiry to the group managing section 112 to obtain the group identification information associated with the terminal identification information D7002 of the mobile terminal 31, and then associates the terminal identification information D7002 of the mobile terminal 31 with the group identification information G1234567 of the group to which the manager's terminal 30 belongs.

(Modification Example of Embodiment 2)

The descriptions as to the Step S201 described in Embodiment 2 assumed that the terminal invitation instruction contains the group identification information of the group which the subject terminal is to be registered to join. However, the terminal invitation instruction may contain, instead of the group identification information of the group which the subject terminal is to be registered to join, invitation information indicating the intention of the manager's terminal 30 to invite the subject terminal. The following deals with a modification example of the first registration process described in Embodiment 2.

According to the above arrangement, in the Step S204, the control section of the mobile terminal 31 transmits, to the server 10, (1) the terminal identification information D7002 of the mobile terminal 31 and (2) the invitation information indicating the intention of the manager's terminal 30 to invite the subject terminal.

In the Step S205, the group managing section 112 of the server 10 identifies, as the group identification information of the group which the subject terminal is to be registered to join, the group identification information G1234567 of the group associated with the terminal identification information D7001 of the manager's terminal 30, which invites the subject terminal. Further, the group managing section 112 manages the terminal identification information D7002 of the mobile terminal 31 and the group identification information G1234567 of the group which the subject terminal is to be registered to join, in such a manner that the terminal identification information D7002 and the group identification information G1234567 are associated with each other.

As described above, the terminal invitation instruction is arranged to contain the invitation information indicating the intention of the manager's terminal 30 to invite the subject terminal, instead of the group identification information of the group which the subject terminal is to be registered to join. Even this arrangement enables the server 10 to perform the first registration process.

By completing the first registration process, the servers 10 in Embodiment 2 and in the modification example of Embodiment 2 achieve the objective of obtaining the consent from the user who uses the subject terminal. As a result, the mobile terminal 31, which is the subject terminal to be registered, becomes a registered terminal in the SNS group, so that the mobile terminal 31 can use the SNS.

Note that the mobile terminals 31 in accordance with Embodiment 2 and the modification example of Embodiment 2 are an example of a terminal that can obtain a service (SNS) offered by a system (SNS system 1) which offers the service to a terminal registered on the server 10.

The mobile terminal 31 as an example of such a terminal includes a sending unit, a receiving unit, a displaying unit, and an operating unit. In making access to the server 10, the control section 302, which serves as the sending unit, transmits, to the server 10, the terminal identification information of the mobile terminal 31. The control section 302, which serves as the receiving unit, receives, prior to obtaining a service of the SNS, the use condition that should be consented to by the user of the mobile terminal 31 and the acceptance object for accepting the input indicating the user's consent to the use condition. The display section 305, which serves as the displaying unit, displays thereon the use condition and the acceptance object, both of which are received by the control section 302. The operating section 304, which serves as the operating unit, performs an input indicating the consent to the acceptance object. The control section 302, which serves as the sending unit, transmits, to the server 10, information indicating that the input indicating the consent has been performed. Thereafter, in making access to the server 10, the control section 302 transmits, to the server 10, the terminal identification information of the mobile terminal 31.

The control section 302 causes the mobile terminal 31 to function as a terminal using the SNS by executing various kinds of instructions that are contained in a program developed on the storage section 303. More specifically, the control section 302 causes the mobile terminal 31 to function as the sending section (sending unit) and the receiving section (receiving unit) by executing various kinds of instructions contained in the program.

### Embodiment 3

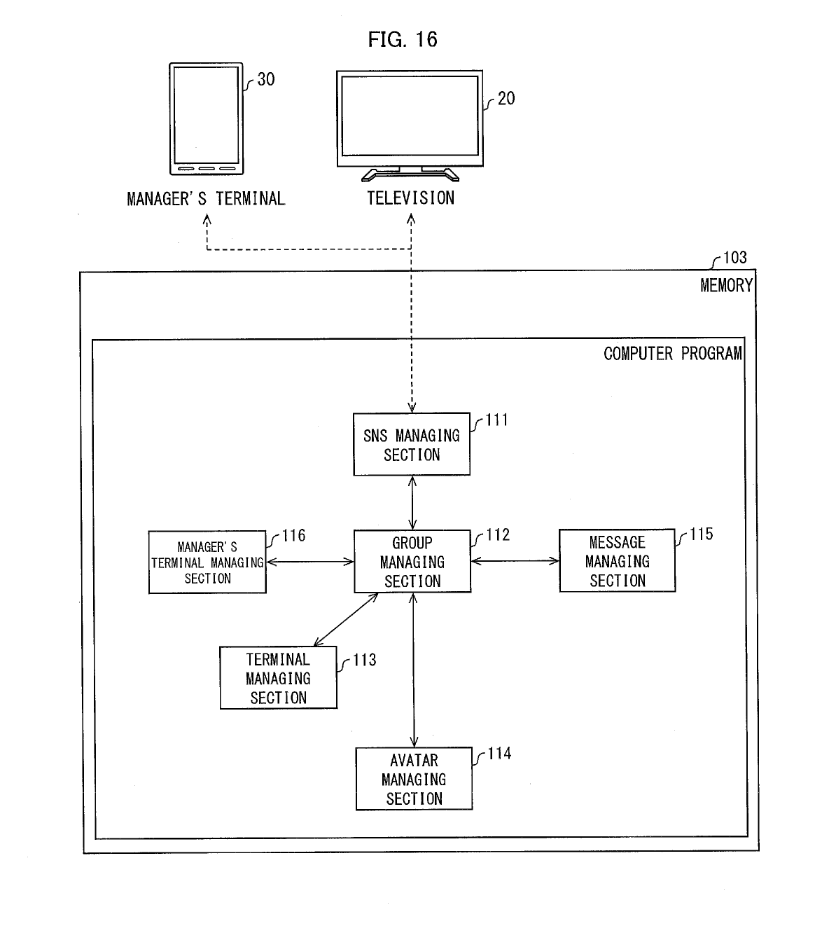

The following will describe Embodiment 3 of the present invention with reference to FIGS. 16 through 18. For convenience of explanation, members of Embodiment 3 that are identical in function to their respective corresponding members described in Embodiments 1 and 2 are each assigned a common reference numeral, and are not described here.

By completing the first registration process described in Embodiments 1 and 2, the server 10 achieves the objective of obtaining the consent from the user who uses the subject terminal. It is more preferable that the server 10 performs not only the first registration process, but also a second registration process described below, in order to obtain the consent from the manager of the SNS and other user who has already joined the SNS.

FIG. 16 is a functional block diagram illustrating the configuration of the server 10 in accordance with the present embodiment. The server 10 in accordance with the present embodiment is different from the server 10 in accordance with Embodiment 1 in that the server 10 in accordance with the present embodiment further includes the group managing section 112. As described earlier, the group managing section 112 manages groups each of which is a unit of entity in which a message is shared in the SNS system 1.

The SNS managing section 111 of the server 10 is configured to perform wireless communications with the manager's terminal 30 and the television 20, which is a subject terminal to be registered, through the communication section 101.

(Second Registration Process Involved with the SNS)

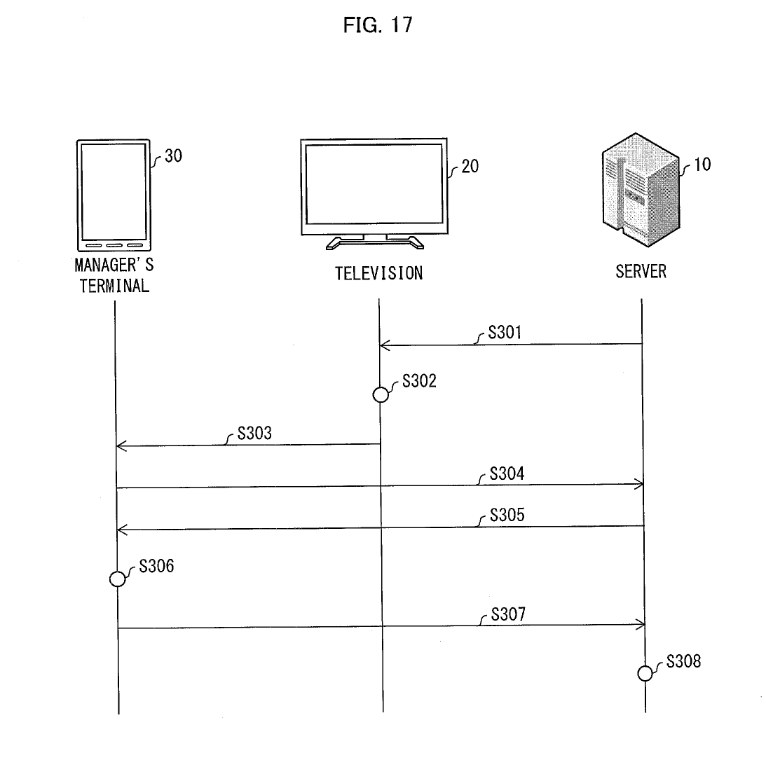

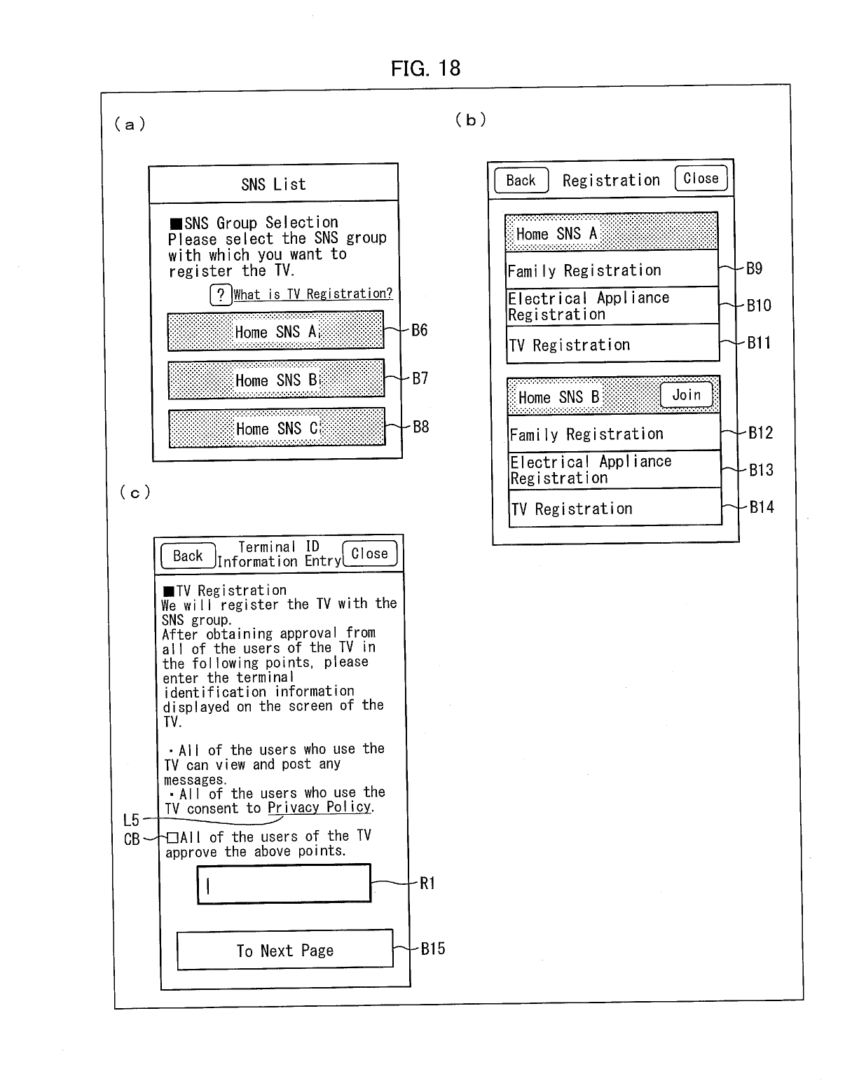

The following will describe the flow of a process for performing a second registration of the television 20 on the SNS, which second registration follows the first registration process described in Embodiment 1, with reference to FIGS. 17 and 18. FIG. 17 is a sequence diagram showing a flow of the second registration process involved with the SNS offered by the server 10. FIG. 18 is a view illustrating a screen shot of a screen displayed on the manager's terminal 30 during the second registration process.

The descriptions in the present embodiment assume that the second use condition is a privacy policy.

In Step S301, upon completion of the first registration, in the Step S110 of FIG. 11, of setting the terminal identification information of the television 20 as the terminal identification information of the terminal that is permitted to be registered, the server 10 initiates the second registration process. The SNS managing section 111, which serves as the transmitting unit, transmits, to the television 20, information for identifying the television 20 that is the subject terminal. The information for identifying the television 20 that is the subject terminal is the terminal identification information of the television 20 and may be, alternatively, a QR Code® containing the terminal identification information of the television 20. Here, the information for identifying the television 20 is assumed as the terminal identification information of the television 20 and as QR Code® data containing the terminal identification information of the television 20 and representing a QR Code® that serves as a link to a page for performing the second registration process.

In Step S302, the control section 202 of the television 20 causes the display section 203 to display thereon (a) the received terminal identification information of the television 20 and (b) the QR Code® represented by the QR Code® data containing the terminal identification information of the television 20.

In Step S303, the father, who is the manager, photographs the QR Code® displayed on the display section 203 of the television 20, by using the photographing section 306 of the manager's terminal 30. On the display section 305 of the manager's terminal 30, the page for performing the second registration process is displayed in accordance with the QR code data representing the QR Code®. Then, when the father logs in as the manager, a screen illustrated in (a) of FIG. 18 is displayed on the display section 305 of the manager's terminal 30. The screen illustrated in (a) of FIG. 18 is a screen for making a selection of a group to register the television 20 with from among the groups managed by the manager's terminal 30.

In Step S304, in a case where the father wishes to register the television 20 with a group “Home SNS A”, the father taps a button B6 saying “Home SNS A”. In response to the tap, the control section 302 of the manager's terminal 30 transmits, to the server 10, a request for performing the second registration, which request contains (a) the terminal identification information of the manager's terminal 30, (b) the terminal identification information of the television 20, (c) the group identification information of the “Home SNS A”, which is the group with which the television 20 is to be registered, and (d) a registration instruction to register the television 20 with the “Home SNS A”.

In the Steps S303 and S304, the father photographed the QR code displayed on the display section 203 of the television 20 to display, on the display section 305 of the manager's terminal 30, the page for making a selection of a SNS group to register the television 20 with. Alternatively, the father may enter the terminal identification information of the television 20 which information is displayed on the display section of the television 20 or may enter, by any other method, a URL corresponding to the page for performing the registration process to make access to that page. Even through these operations, the same process can be performed.

Specifically, in the Step S303, the father as the manager logs in to the SNS and then selects a terminal registration menu The control section 302 of the manager's terminal 30 causes the display section 305 to display thereon a screen illustrated in (b) of FIG. 18. In the screen illustrated in (b) of FIG. 18, SNS groups managed by the father as the manager are displayed. For each SNS managed by the father, buttons saying “Family Registration”, “Electrical Appliance Registration”, and “TV Registration” are displayed. As an example, take the “Home SNS A”, which is one of the groups managed by the father. In a case where the father wishes to register a terminal used by his family with that group, the father taps a button B9. In a case where the father wishes to register an electrical appliance (e.g. a cleaning robot) with that group, the father taps a button B10. In a case where the father wishes to register a television with that group, the father taps a button B11. The same applies to buttons B12 to B14, which are provided for a “Home SNS B”.

Thus, in a case where the father wishes to register the television 20 with the group “Home SNS A”, the father taps the button B11 in the Step S304. In response to the tap, the control section 302 of the manager's terminal 30 transmits, to the server 10, a request for performing the second registration, which request contains (a) the terminal identification information of the manager's terminal 30, (b) the terminal identification information of the television 20, (c) the group identification information of the “Home SNS A”, which is the group with which the television 20 is to be registered, and (d) the registration instruction to register the television 20 with the “Home SNS A”.

In Step S305, upon receipt of the request for performing the second registration from the manager's terminal 30, the SNS managing section 111, which serves as the transmitting unit, transmits, to the manager's terminal 30, information for causing the manager's terminal 30 to display thereon the second use condition that should be consented by the user at the registration, and information for causing the manager's terminal 30 to display thereon an acceptance object for accepting a second input indicating the user's consent to the second use condition. The descriptions in the present embodiment assume that the second use condition is a privacy policy that should be consented by the user at the registration.

In Step S306, upon receipt of the information for causing the manager's terminal 30 to display thereon the privacy policy and the information for causing the manager's terminal 30 to display thereon the acceptance object for accepting the input indicating the user's consent to the privacy policy, the manager's terminal 30 causes the display section 305 to display thereon a screen illustrated in (c) of FIG. 18. The screen illustrated in (c) of FIG. 18 contains a message prompting the father, who is the manager, to obtain approval from all of the users of the television 20 in the following points:
All of the users who use the television 20 can view any messages posted on the “Home SNS A” and post any messages on the “Home SNS A”; and
All of the users who use the television 20 consent to the privacy policy which is the second use condition.

In the screen illustrated in (c) of FIG. 18, a link L5 saying “Privacy Policy” is a link for displaying the privacy policy which is the second use condition. When the user (basically, the father) of the manager's terminal 30 taps the link L5, the privacy policy is displayed on the display section 305 of the manager's terminal 30.

In the screen illustrated in (c) of FIG. 18, a checkbox CB with the statement saying “All of the users of the TV approve the above points”. and a button B15 saying “To Next Page” are pieces of information for displaying the acceptance object for accepting the user's input when the user consents to the privacy policy. A region R1 is a region where the terminal identification information of the subject terminal to be registered is entered.

The father can input, to the manager's terminal 30, the consent to the privacy policy by entering the terminal identification information of the television 20 in the region R1, placing a checkmark in the checkbox CB, and then tapping the button B15 saying “To Next Page”.

In the case where the father wishes to register the television 20 with “Home SNS A”, the father, after obtaining approval from all of the users who use the television 20 in the above points, enters the terminal identification information of the television 20 in the region R1, places a checkmark in the checkbox CB, and then taps the button B15.

In Step S307, upon accepting the father's input indicating the consent to the privacy policy, the control section 302 of the manager's terminal 30 causes the communication section 301 to transmit, to the server 10, (a) information indicating the acceptance of the input indicating the consent to the privacy policy and (b) the terminal identification information of the television 20.

In Step S308, in a case where the SNS managing section 111 of the server 10 receives, from the television 20, (a) the information indicating the acceptance of the input indicating the consent to the privacy policy, and (b) the terminal identification information of the television 20, the terminal managing section 113 performs the second registration by setting the terminal identification information of the television 20, which has been completed for the first registration, as the terminal identification information being associated with the group identification information of the “Home SNS A”.

### Embodiment 4

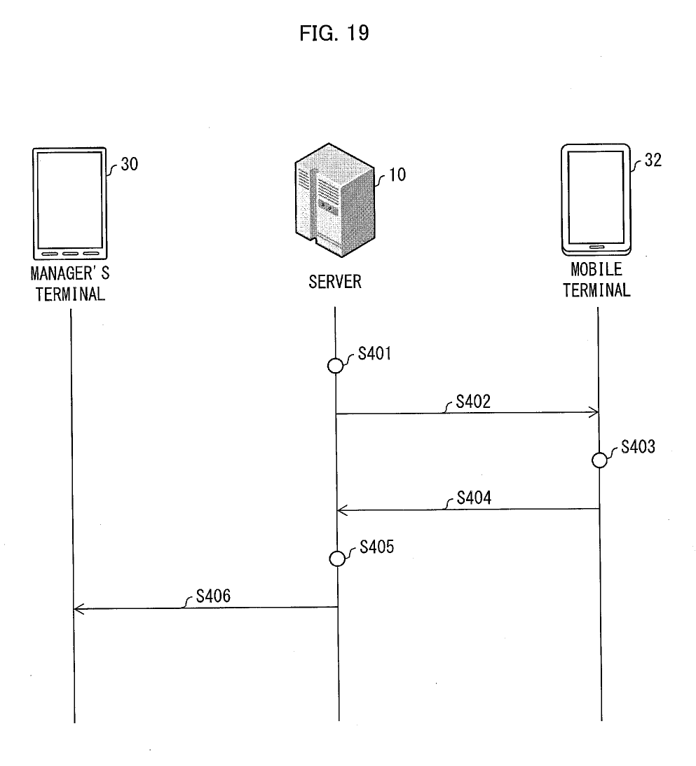

The following will describe Embodiment 4 of the present invention with reference to FIG. 19. For convenience of explanation, members of Embodiment 4 that are identical in function to their respective corresponding members described in Embodiments 1, 2, and 3 are each assigned a common reference numeral, and are not described here.

In Embodiment 4, an embodiment will be described in which, in the second registration process described in Embodiment 3, a terminal registered with a subject group with which the television 20 is to be registered is prompted to make an input indicating the consent to the privacy policy that is the second use condition. The descriptions in the present embodiment assume that the mobile terminal 32 owned by the child has already been registered with the “Home SNS A”, which is the subject group with which the television 20 is to be registered. It can be said that the mobile terminal 32 is one of the terminals belonging to the group to which the manager's terminal 30 belongs and being neither the manager's terminal 30 nor the subject terminal. In the present embodiment, the terminal belonging to the group to which the manager's terminal 30 belongs and being neither the manager's terminal 30 nor the subject terminal may be one terminal or may be a plurality of terminals.

FIG. 19 is a sequence diagram showing a part of the flow of the second registration process involved with the SNS offered by the server 10. The sequence in accordance with the present embodiment is performed during a time period between the Step S304 and the Step S305, which are shown in FIG. 17. In the Step S304, the control section 302 of the manager's terminal 30 transmits, to the server 10, a request for performing the second registration required to register the television 20 with the “Home SNS A”.

In Step S401, the SNS managing section 111 of the server 10 receives the request, transmitted from the manager's terminal 30, for performing the second registration required to register the television 20 with the “Home SNS A”. The group managing section 112 extracts, from the auxiliary storage device 104, the terminal identification information of each of the terminals associated with the group identification information of the group “Home SNS A”. In other words, the group managing section 112 extracts, from the auxiliary storage device 104, the terminal identification information of each of the terminals belonging to the group “Home SNS A”.

In Step S402, the SNS managing section 111 causes the communication section 101 to transmit, to each of the terminals having their respective pieces of terminal identification information extracted by the group managing section 112, information for causing each of the terminals to display thereon a message that the request for performing the second registration of the television 20 on the “Home SNS A” is being made, information for causing each of the terminals to display thereon the privacy policy (second use condition), and information for causing each of the terminals to display thereon an acceptance object for accepting an input (second input) indicating the user's consent to the privacy policy. In FIG. 19, the mobile terminal 32 of the child is shown as an example of the terminals belonging to the group “Home SNS A”.

In Step S403, the control section of the mobile terminal 32 causes the display section to display thereon, based on the pieces of information received from the server 10, a message that the request for performing the second registration of the television 20 on the “Home SNS A” is being made, a link for displaying the privacy policy, and a checkbox and a button, both of which serves as the acceptance object for accepting the input indicating the user's consent to the privacy policy. The child who uses the mobile terminal 32 taps the link for displaying the privacy policy to display the privacy policy on the mobile terminal 32. In a case where the child consents to the displayed privacy policy and approves the second registration of the television 20 on the “Home SNS A”, the child places a checkmark in the checkbox, which is the acceptance object for accepting the input indicating the user's consent to the privacy policy, and then taps the button.

In Step S404, upon accepting the input indicating the user's consent to the privacy policy, the control section of the mobile terminal 32 transmits, to the server 10, (a) information indicating the acceptance of the input indicating the consent to the privacy policy and (b) the terminal identification information D7003 of the mobile terminal 32.

In Step S405, the SNS managing section 111, which serves as the receiving unit, determined whether or not it has received, from at least one of the terminals belonging to the group to which the manager's terminal 30 belongs and being neither the manager's terminal 30 nor the subject terminal, the terminal identification information of that terminal and the information indicating the acceptance of the input indicating the consent to the privacy policy.

In Step S406, upon determining that the SNS managing section 111 has received, from at least one of the terminals belonging to the group to which the manager's terminal 30 belongs and being neither the manager's terminal 30 nor the subject terminal, the terminal identification information of that terminal and the information indicating the acceptance of the input indicating the consent to the privacy policy, the SNS managing section 111 transmits, to the manager's terminal 30, information for causing the manager's terminal 30 to display thereon the privacy policy and information for causing the manager's terminal 30 to display thereon an acceptance object for accepting the input indicating the user's consent to the privacy policy. The Step S406 corresponds to the Step S305 in Embodiment 3.

Note that the arrangement in the Step S406 may be alternatively such that, upon determining that the SNS managing section 111 has received, from all of the terminals belonging to the group to which the manager's terminal 30 belongs and being neither the manager's terminal 30 nor the subject terminal, respective pieces of terminal identification information of those terminals and pieces of information each indicating the acceptance of the input indicating the consent to the privacy policy, the SNS managing section 111 transmits, to the manager's terminal 30, the information for causing the manager's terminal 30 to display thereon the privacy policy and the information for causing the manager's terminal 30 to display thereon an acceptance object for accepting the input indicating the user's consent to the privacy policy.

### Embodiment 5

Control blocks (particularly, the SNS managing section 111, the group managing section 112, and the terminal managing section 113) provided in the server 10 may be realized by a logic circuit (hardware) provided in an integrated circuit (IC chip) or the like or may be realized by software as executed by a CPU (Central Processing Unit).

Control blocks (particularly, the sending section and the receiving section) provided in the television 20 and the mobile terminal 31 may be realized by a logic circuit (hardware) provided in an integrated circuit (IC chip) or the like or may be realized by software as executed by a CPU (Central Processing Unit).

In the case where the control blocks are implemented by software as executed by a CPU, the server 10, the television 20, and the mobile terminal 31 each include: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium such as a communication network and a broadcast wave) which enables transmission of the program. Note that the present invention can also be implemented by the program in the form of a data signal embedded in a carrier wave which is embodied by electronic transmission.

[Outline]

A server (10) in accordance with Aspect 1 of the present invention includes:

a receiving unit (SNS managing section 111) configured to receive terminal identification information of a subject terminal (television 20, mobile terminal 31), which is a terminal to be registered;

a terminal managing unit (terminal managing section 113) configured to manage the terminal identification information of the subject terminal and determining whether or not the terminal identification information of the subject terminal has already been registered; and

a transmitting unit (SNS managing section 111) configured to, in a case where the terminal managing unit determines that the terminal identification information of the subject terminal has not already been registered, transmit, to the subject terminal, the following pieces of information:
information for causing the subject terminal to display thereon a first use condition (terms of use) that should be consented to by a user at the registration; and
information for causing the subject terminal to display thereon an acceptance object for accepting a first input indicating a user's consent to the first use condition,

in a case where the receiving unit receives, from the subject terminal, information indicating acceptance of the first input and the terminal identification information of the subject terminal, the terminal managing unit performing a first registration of the terminal identification information of the subject terminal.

According to the above arrangement, in a case where the terminal managing unit determines that the terminal identification information of the subject terminal has not already been registered, the transmitting unit transmits, to the subject terminal, the following pieces of information: information for causing the subject terminal to display thereon a first use condition that should be consented to by a user at the registration; and information for causing the subject terminal to display thereon an acceptance object for accepting a first input indicating a user's consent to the first use condition. Further, in a case where the receiving unit receives, from the subject terminal, information indicating acceptance of the first input and the terminal identification information of the subject terminal, the terminal managing unit performs a first registration of the terminal identification information of the subject terminal. Thus, it is possible to provide a server capable of affording facilities to obtain a consent to the use condition of the networking service from the user who uses the networking service.

A server in accordance with Aspect 2 of the present invention may be arranged in the Aspect 1 to further include:

a group managing unit configured to, in a case where the receiving unit receives, from a manager's terminal, not only the terminal identification information of the subject terminal, but also one of (i) group identification information of a group to which the manager's terminal belongs and (ii) invitation information indicating an intention of the manager's terminal to invite the subject terminal, manage the terminal identification information of the subject terminal and the group identification information of the group to which the manager's terminal belongs in such a manner so as to associate the terminal identification information of the subject terminal with the group identification information of the group to which the manager's terminal belongs,

in a case where the receiving unit receives, from the subject terminal, the information indicating acceptance of the first input and the terminal identification information of the subject terminal, the terminal managing unit performing the first registration of the terminal identification information of the subject terminal in such a manner so as to associate the terminal identification information of the subject terminal with the group identification information of the group to which the manager's terminal belongs.

According to the above arrangement, in a case where the receiving unit receives, from a manager's terminal, not only the terminal identification information of the subject terminal, but also one of (i) group identification information of a group to which the manager's terminal belongs and (ii) invitation information indicating an intention of the manager's terminal to invite the subject terminal, the terminal managing unit can perform the first registration of the terminal identification information of the subject terminal in such a manner so as to associate the terminal identification information of the subject terminal with the group identification information of the group to which the manager's terminal belongs.

A server in accordance with Aspect 3 of the present invention may be arranged in the Aspect 1 or 2 such that

after the terminal managing unit performs the first registration of the terminal identification information of the subject terminal,

the transmitting unit transmits, to the subject terminal, information for identifying the subject terminal,

the receiving unit receives, from the manager's terminal, the following pieces of information:
terminal identification information of the manager's terminal;
the terminal identification information of the subject terminal; and
a registration instruction to register the subject terminal with the group to which the manager's terminal belongs,

the transmitting unit transmits, to the manager's terminal, the following pieces of information:
information for causing the manager's terminal to display thereon a second use condition that should be consented to by the user at the registration; and
information for causing the manager's terminal to display thereon an acceptance object for accepting a second input indicating a user's consent to the second use condition,

in a case where the receiving unit receives, from the manager's terminal, information indicating acceptance of the second input, the terminal managing unit performs the second registration of the terminal identification information of the subject terminal in such a manner so as to associate the terminal identification information of the subject terminal with the group to which the manager's terminal belongs.

According to the above arrangement, after the terminal managing unit performs the first registration of the terminal identification information of the subject terminal, in a case where the receiving unit receives, from the manager's terminal, information indicating acceptance of the second input, the terminal managing unit performs the second registration of the terminal identification information of the subject terminal in such a manner so as to associate the terminal identification information of the subject terminal with the group to which the manager's terminal belongs. Thus, it is possible to perform the second registration of the subject terminal in such a state that the user is regarded as consenting to the second use condition that should be consented to by the user at the registration.

A server in accordance with Aspect 4 of the present invention may be arranged in the Aspect 2 or 3 such that

the transmitting unit transmits, to one or more other terminals belonging to the group to which the manager's terminal belongs and being neither the manager's terminal nor the subject terminal, the following pieces of information:
information for causing the other terminal(s) to display thereon a second use condition that should be consented to by the user at the registration; and
information for causing the other terminal(s) to display thereon an acceptance object for accepting a second input indicating a user's consent to the second use condition, and

in a case where the receiving unit receives, from at least one of the other terminal(s), the following pieces of information:
information indicating acceptance of the second input; and
terminal identification information of the other terminal(s),

the transmitting unit transmits, to the manager's terminal, the following pieces of information:
(a) information for causing the manager's terminal to display thereon the second use condition that should be consented to by the user at the registration; and
(b) information for causing the manager's terminal to display thereon an acceptance object for accepting a second input indicating a user's consent to the second use condition.

According to the above arrangement, it is possible to obtain a consent to the second use condition that should be consented to by the user at the registration, from any of one or more other terminals belonging to the group to which the manager's terminal belongs and being neither the manager's terminal nor the subject terminal.

A server in accordance with Aspect 5 of the present invention may be arranged in the Aspect 4 such that

in a case where the receiving unit receives, from all of the other terminal(s), the information indicating acceptance of the second input and the terminal identification information of the other terminal(s), the transmitting unit transmits the pieces of information (a) and (b) to the manager's terminal.

According to the above arrangement, it is possible to obtain a consent to the second use condition that should be consented to by the user at the registration, from all of one or more other terminals belonging to the group to which the manager's terminal belongs and being neither the manager's terminal nor the subject terminal.

A terminal management method in accordance with Aspect 6 of the present invention includes:

a first reception step (Step S102) of receiving terminal identification information of a subject terminal (television 20), which is a terminal to be registered;

a terminal management step (Step S103) of managing the terminal identification information of the subject terminal and determining whether or not the terminal identification information of the subject terminal has already been registered;

a first transmission step (Step S104) of, in a case where it is determined in the terminal management step that the terminal identification information of the subject terminal has not already been registered, transmitting, to the subject terminal, the following pieces of information:
information for causing the subject terminal to display thereon a first use condition that should be consented to by a user at the registration; and
information for causing the subject terminal to display thereon an acceptance object for accepting a first input indicating a user's consent to the first use condition; and

a first registration step (Step S107) of, upon receipt of information indicating acceptance of the first input and the terminal identification information of the subject terminal from the subject terminal, performing a first registration of the terminal identification information of the subject terminal.

The above arrangement yields the same effect as that yielded by the server in accordance with the Aspect 1 of the present invention.

A terminal management method in accordance with Aspect 7 of the present invention may be arranged in the Aspect 6 to further include:

a group management step of, in a case where the first reception step receives, from a manager's terminal, not only the terminal identification information of the subject terminal, but also one of (i) group identification information of a group to which the manager's terminal belongs and (ii) invitation information indicating an intention of the manager's terminal to invite the subject terminal, managing the terminal identification information of the subject terminal and the group identification information of the group to which the manager's terminal belongs in such a manner so as to associate the terminal identification information of the subject terminal with the group identification information of the group to which the manager's terminal belongs,

upon receipt of, from the subject terminal, the information indicating acceptance of the first input and the terminal identification information of the subject terminal, the first registration step performing the first registration of the terminal identification information of the subject terminal in such a manner so as to associate the terminal identification information of the subject terminal with the group identification information of the group to which the manager's terminal belongs.

The above arrangement yields the same effect as that yielded by the server in accordance with the Aspect 2 of the present invention.

A terminal management method in accordance with Aspect 8 of the present invention may be arranged in the Aspect 6 to further include:

a second transmission step of transmitting, to the subject terminal, information for identifying the subject terminal;

a second reception step of receiving, from the manager's terminal, the following pieces of information:
terminal identification information of the manager's terminal;
the terminal identification information of the subject terminal; and
a registration instruction to register the subject terminal with the group to which the manager's terminal belongs,

a third transmission step of transmitting, to the manager's terminal, the following pieces of information:
information for causing the manager's terminal to display thereon a second use condition that should be consented to by the user at the registration; and
information for causing the manager's terminal to display thereon an acceptance object for accepting a second input indicating a user's consent to the second use condition; and

a second registration step of, upon receipt of, from the manager's terminal, information indicating acceptance of the second input, performing the second registration of the terminal identification information of the subject terminal in such a manner so as to associate the terminal identification information of the subject terminal with the group to which the manager's terminal belongs,

the second transmission step, the second reception step, the third transmission step, and the second registration step following the first registration step.

The above arrangement yields the same effect as that yielded by the server in accordance with the Aspect 3 of the present invention.

A terminal management method in accordance with Aspect 9 of the present invention may be arranged in the Aspect 7 or 8 to further include:

a fourth transmission step of transmitting, to one or more other terminals belonging to the group to which the manager's terminal belongs and being neither the manager's terminal nor the subject terminal, the following pieces of information:
information for causing the other terminal(s) to display thereon a second use condition that should be consented to by the user at the registration; and
information for causing the other terminal(s) to display thereon an acceptance object for accepting a second input indicating a user's consent to the second use condition; and

a fifth transmission step of, upon receipt of, from at least one of the other terminal(s), the following pieces of information:
information indicating acceptance of the second input; and
terminal identification information of the other terminal(s),

transmitting, to the manager's terminal, the following pieces of information:
(a) information for causing the manager's terminal to display thereon the second use condition that should be consented to by the user at the registration; and
(b) information for causing the manager's terminal to display thereon an acceptance object for accepting a second input indicating a user's consent to the second use condition.

The above arrangement yields the same effect as that yielded by the server in accordance with the Aspect 4 of the present invention.

A terminal in accordance with Aspect 10 of the present invention is a terminal (television 20, mobile terminal 31) adapted to obtain a service offered, in a system for determining whether or not the service is to be offered to the terminal by identifying the terminal before offering the service, the system including a server and at least one terminal, the terminal including: a sending unit (control sections 202 and 302) configured to, in making access to the server, send terminal identification information to the server;

a receiving unit (control sections 202 and 302) configured to, before obtaining the service offered, receive (i) a use condition that should be consented to by a user of the terminal and (ii) an acceptance object for accepting an input indicating a user's consent to the use condition;

a displaying unit (203, 305) configured to display the use condition and the acceptance object, both of which are received by the receiving unit; and

an operating unit (remote controller 25, operating section 304) configured to make, on the acceptance object, the input indicating the consent,

the sending unit sending, to the server, information indicating that the input indicating the consent has been performed, and then transmitting, to the server, the terminal identification information in making access to the server.

According to the above arrangement, a terminal adapted to obtain a service offered, in a system in which the service is offered to a terminal registered on the server, can transmit, to the server, information indicating that an input indicating the consent to the use condition of the service has been performed. Thus, it is possible to provide a terminal capable of affording facilities so that the user who uses the service consents to the use condition of the service.

Note that each of the servers in accordance with the aspects of the present invention may be realized by a computer. In this case, the present invention also encompasses: a program for allowing a computer to serve as the server by causing the computer to operate as the foregoing units provided in the server; and a storage medium storing the program therein.

The present invention is not limited to the descriptions of the Embodiments, but can be altered by a person skilled in the art within the scope of the claims. An embodiment derived from a proper combination of technical units disclosed in different embodiments is also encompassed in the technical scope of the present invention. Moreover, a novel technical feature can be created by a combination of technical units disclosed in these embodiments.

### INDUSTRIAL APPLICABILITY

The present invention is applicable to a server that offers a social networking service to enable a message to be shared among individual terminals, a terminal management method, a terminal, and a storage medium.

### REFERENCE SIGNS LIST

1 SNS system
10 Server
101 Communication section
102 Control section
103 Main storage device
104 Auxiliary storage device
111 SNS managing section
112 Group managing section
113 Terminal managing section
114 Avatar managing section
115 Message managing section
116 Manager's terminal managing section
20 Television
30 Mobile terminal

1. A server comprising:
a receiving unit configured to receive terminal identification information of a subject terminal, which is a terminal to be registered;
a terminal managing unit configured to manage the terminal identification information of the subject terminal and determining whether or not the terminal identification information of the subject terminal has already been registered; and
a transmitting unit configured to, in a case where the terminal managing unit determines that the terminal identification information of the subject terminal has not already been registered, transmit, to the subject terminal, the following pieces of information:
information for causing the subject terminal to display thereon a first use condition that should be consented to by a user at the registration; and
information for causing the subject terminal to display thereon an acceptance object for accepting a first input indicating a user's consent to the first use condition,
in a case where the receiving unit receives, from the subject terminal, information indicating acceptance of the first input and the terminal identification information of the subject terminal, the terminal managing unit performing a first registration of the terminal identification information of the subject terminal.

2. The server according to claim 1, further comprising:
a group managing unit configured to, in a case where the receiving unit receives, from a manager's terminal, not only the terminal identification information of the subject terminal, but also one of (i) group identification information of a group to which the manager's terminal belongs and (ii) invitation information indicating an intention of the manager's terminal to invite the subject terminal, manage the terminal identification information of the subject terminal and the group identification information of the group to which the manager's terminal belongs in such a manner so as to associate the terminal identification information of the subject terminal with the group identification information of the group to which the manager's terminal belongs,
in a case where the receiving unit receives, from the subject terminal, the information indicating acceptance of the first input and the terminal identification information of the subject terminal, the terminal managing unit performing the first registration of the terminal identification information of the subject terminal in such a manner so as to associate the terminal identification information of the subject terminal with the group identification information of the group to which the manager's terminal belongs.

3. The server according to claim 1, wherein
after the terminal managing unit performs the first registration of the terminal identification information of the subject terminal,
the transmitting unit transmits, to the subject terminal, information for identifying the subject terminal,
the receiving unit receives, from the manager's terminal, the following pieces of information:
terminal identification information of the manager's terminal;
the terminal identification information of the subject terminal; and
a registration instruction to register the subject terminal with the group to which the manager's terminal belongs,
the transmitting unit transmits, to the manager's terminal, the following pieces of information:
information for causing the manager's terminal to display thereon a second use condition that should be consented to by the user at the registration; and
information for causing the manager's terminal to display thereon an acceptance object for accepting a second input indicating a user's consent to the second use condition,
in a case where the receiving unit receives, from the manager's terminal, information indicating acceptance of the second input, the terminal managing unit performs the second registration of the terminal identification information of the subject terminal in such a manner so as to associate the terminal identification information of the subject terminal with the group to which the manager's terminal belongs.

4. The server according to claim 2, wherein
the transmitting unit transmits, to one or more other terminals belonging to the group to which the manager's terminal belongs and being neither the manager's terminal nor the subject terminal, the following pieces of information:
information for causing the other terminal(s) to display thereon a second use condition that should be consented to by the user at the registration; and
information for causing the other terminal(s) to display thereon an acceptance object for accepting a second input indicating a user's consent to the second use condition, and
in a case where the receiving unit receives, from at least one of the other terminal(s), the following pieces of information:
information indicating acceptance of the second input; and
terminal identification information of the other terminal(s),
the transmitting unit transmits, to the manager's terminal, the following pieces of information:
(a) information for causing the manager's terminal to display thereon the second use condition that should be consented to by the user at the registration; and
(b) information for causing the manager's terminal to display thereon an acceptance object for accepting a second input indicating a user's consent to the second use condition.

5. The server according to claim 4, wherein
in a case where the receiving unit receives, from all of the other terminal(s), the information indicating acceptance of the second input and the terminal identification information of the other terminal(s), the transmitting unit transmits the pieces of information (a) and (b) to the manager's terminal.

6. A terminal management method comprising:
a first reception step of receiving terminal identification information of a subject terminal, which is a terminal to be registered;
a terminal management step of managing the terminal identification information of the subject terminal and determining whether or not the terminal identification information of the subject terminal has already been registered;
a first transmission step of, in a case where it is determined in the terminal management step that the terminal identification information of the subject terminal has not already been registered, transmitting, to the subject terminal, the following pieces of information:
information for causing the subject terminal to display thereon a first use condition that should be consented to by a user at the registration; and
information for causing the subject terminal to display thereon an acceptance object for accepting a first input indicating a user's consent to the first use condition; and
a first registration step of, upon receipt of information indicating acceptance of the first input and the terminal identification information of the subject terminal from the subject terminal, performing a first registration of the terminal identification information of the subject terminal.

7. The terminal management method according to claim 6, further comprising:
a group management step of, in a case where the first reception step receives, from a manager's terminal, not only the terminal identification information of the subject terminal, but also one of (i) group identification information of a group to which the manager's terminal belongs and (ii) invitation information indicating an intention of the manager's terminal to invite the subject terminal, managing the terminal identification information of the subject terminal and the group identification information of the group to which the manager's terminal belongs in such a manner so as to associate the terminal identification information of the subject terminal with the group identification information of the group to which the manager's terminal belongs,
upon receipt of, from the subject terminal, the information indicating acceptance of the first input and the terminal identification information of the subject terminal, the first registration step performing the first registration of the terminal identification information of the subject terminal in such a manner so as to associate the terminal identification information of the subject terminal with the group identification information of the group to which the manager's terminal belongs.

8. The terminal management method according to claim 6, further comprising:
a second transmission step of transmitting, to the subject terminal, information for identifying the subject terminal;
a second reception step of receiving, from the manager's terminal, the following pieces of information:
terminal identification information of the manager's terminal;
the terminal identification information of the subject terminal; and
a registration instruction to register the subject terminal with the group to which the manager's terminal belongs,
a third transmission step of transmitting, to the manager's terminal, the following pieces of information:
information for causing the manager's terminal to display thereon a second use condition that should be consented to by the user at the registration; and
information for causing the manager's terminal to display thereon an acceptance object for accepting a second input indicating a user's consent to the second use condition; and
a second registration step of, upon receipt of, from the manager's terminal, information indicating acceptance of the second input, performing the second registration of the terminal identification information of the subject terminal in such a manner so as to associate the terminal identification information of the subject terminal with the group to which the manager's terminal belongs,
the second transmission step, the second reception step, the third transmission step, and the second registration step following the first registration step.

9. The terminal management method according to claim 7, further comprising:
a fourth transmission step of transmitting, to one or more other terminals belonging to the group to which the manager's terminal belongs and being neither the manager's terminal nor the subject terminal, the following pieces of information:
information for causing the other terminal(s) to display thereon a second use condition that should be consented to by the user at the registration; and
information for causing the other terminal(s) to display thereon an acceptance object for accepting a second input indicating a user's consent to the second use condition; and
a fifth transmission step of, upon receipt of, from at least one of the other terminal(s), the following pieces of information:
information indicating acceptance of the second input; and
terminal identification information of the other terminal(s),
transmitting, to the manager's terminal, the following pieces of information:
(a) information for causing the manager's terminal to display thereon the second use condition that should be consented to by the user at the registration; and
(b) information for causing the manager's terminal to display thereon an acceptance object for accepting a second input indicating a user's consent to the second use condition.

10. A terminal adapted to obtain a service offered, in a system for determining whether or not the service is to be offered to the terminal by identifying the terminal before offering the service, the system including a server and at least one terminal,
the terminal comprising:
a sending unit configured to, in making access to the server, send terminal identification information to the server;
a receiving unit configured to, before obtaining the service offered, receive (i) a use condition that should be consented to by a user of the terminal and (ii) an acceptance object for accepting an input indicating a user's consent to the use condition;
a displaying unit configured to display the use condition and the acceptance object, both of which are received by the receiving unit; and
an operating unit configured to make, on the acceptance object, the input indicating the consent,
the sending unit sending, to the server, information indicating that the input indicating the consent has been performed, and then transmitting, to the server, the terminal identification information in making access to the server.

11. A non-transitory computer-readable storage medium storing therein a program for causing a computer to function as the server according to claim 1, the program causing the computer to serve as each of the units of the server.
